(19) United States
(12) Patent Application Publication
(10) Pub. No.: US 2025/0380125 A1
(43) Pub. Date: Dec. 11, 2025

(54) RADIO FREQUENCY INTERNET-OF-THINGS DEVICE DISCOVERY

(71) Applicant: QUALCOMM Incorporated, San Diego, CA (US)

(72) Inventors: Ahmed ELSHAFIE, San Diego, CA (US); Seyedkianoush HOSSEINI, San Diego, CA (US); Huilin XU, Temecula, CA (US); Yuchul KIM, San Diego, CA (US); Zhikun WU, Beijing (CN); Linhai HE, San Diego, CA (US); Wei YANG, San Diego, CA (US); Wanshi CHEN, San Diego, CA (US); Peter GAAL, San Diego, CA (US)

(21) Appl. No.: 18/877,972

(22) PCT Filed: Sep. 2, 2022
(86) PCT No.: PCT/CN2022/116783

§ 371 Date: Dec. 20, 2024

(51) Int. Cl. H04W 8/00; H04W 16/28; H04W 24/10

(52) U.S. Cl. CPC H04W 8/005; H04W 16/28; H04W 24/10

(57) ABSTRACT

A radio frequency (RF) IoT device may be configured to receive a group discovery query for a set of IoT devices from an RF source device. The group may be based on at least one of (a) an IoT device class, (b) a measurement type, (c) a data priority, (d) a type of information carried by the set of IoT devices, (e) a presence of data, (f) an amount of the data, (g) a distance from the RF source device, or (h) a set of identifiers for the one or more IoT devices in the group. The RF IoT device may be configured to transmit a response to the group discovery query based on the IoT device belonging to the set of IoT devices.

### TECHNICAL FIELD

The present disclosure relates generally to communication systems, and more particularly, to a system for communicating with radio frequency (RF) Internet-of-things (IoT) devices.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at an IoT device are provided. The apparatus may be configured to receive a group discovery query for a set of IoT devices. The group may be based on at least one of (a) an IoT device class, (b) a measurement type, (c) a data priority, (d) a type of information carried by the set of IoT devices, (e) a presence of data, (f) an amount of the data, (g) a distance from a radio frequency (RF) source device, or (h) a set of identifiers for the one or more IoT devices in the group. The apparatus may be configured to transmit a response to the group discovery query based on the IoT device belonging to the set of IoT devices.

In an aspect of the disclosure, a method, a computer-readable medium, and an apparatus at a wireless device are provided. The apparatus may be configured to transmit a group discovery query for a set of IoT devices. The group may be based on at least one of (a) an IoT device class, (b) a measurement type, (c) a data priority, (d) a type of information carried by the set of IoT devices, (e) a presence of data, (f) an amount of the data, (g) a distance from a radio frequency (RF) source device, or (h) a set of identifiers for the one or more IoT devices in the group. The apparatus may be configured to receive a response to the group discovery query from an IoT device belonging to the set of IoT devices.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of an IoT device and a wireless device in an access network.

FIG. 4A is a diagram illustrating an example of a wireless communications system having a backscattering-based communications device that may reflect or backscatter a signal a first UE to a second UE.

FIG. 4B is a diagram illustrating an example of a radio wave transmitted by a wireless communications device.

FIG. 4C is a diagram illustrating an example of a backscattered signal that modulates the radio wave of FIG. 4B.

FIG. 4D is a diagram illustrating an example of a superposition of the radio wave of FIG. 4B and the radio wave of FIG. 4C.

FIG. 5 is a diagram illustrating an example of an IoT device.

FIG. 6A illustrates example aspects of signals that may be used with an IoT device.

FIG. 6B is a diagram illustrating an example of a backscatter communication timeline.

FIG. 7 is a diagram illustrating another example of a backscatter communication timeline.

FIG. 8 is a communication flow diagram illustrating an RF reader and an IoT device configured to communicate with one another.

FIG. 9 is a flowchart of a method of wireless communication.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

FIG. 16 is a diagram illustrating an example of a hardware implementation for an example network entity.

FIG. 17 is a diagram illustrating an example of a hardware implementation for an example network entity.

### DETAILED DESCRIPTION

An RF source may have one or more IoT devices within its vicinity. An IoT device may be, for example, a radio frequency identifier (RFID) tag device, a backscattering-based communications device, or a user equipment (UE). The UE may contain an RFID tag radio or a backscattering-based communications radio, and may be configured to use such a radio to communicate (e.g., transmit/receive) signals. When an RF source transmits an RF signal, more than one IoT devices may receive the RF signal. The RF source may attempt to discover nearby IoT devices by transmitting a discovery request. Once the RF source receives information about the IoT devices, the RF source may configure such devices to receive commands from, or otherwise communicate with, the RF source, for example by assigning an identifier (ID) to each IoT device. When the RF source attempts to discover IoT devices at a later time, some of the IoT devices may be devices that the RF source previously communicated with, and other IoT devices may be devices that the RF source has not previously communicated with. For example, an IoT device may have recently communicated with the RF source (i.e., an established IoT device) new with respect to the RF source (i.e., a new IoT device) or may have not communicated with the RF source for a long period of time (an expired IoT device). Instead of reconfiguring every IoT device, an RF source may configure new and/or expired IoT devices, and may not configure established IoT devices.

A wireless device configured to discover IoT devices may be configured to transmit a group discovery query for a set of IoT devices. The group may be based on at least one of (a) an IoT device class, (b) a measurement type, (c) a data priority, (d) a type of information carried by the set of IoT devices, (e) a presence of data, (f) an amount of the data, (g) a distance from a radio frequency (RF) source device, or (h) a set of identifiers for the one or more IoT devices in the group. The wireless device may be configured to receive a response to the group discovery query from an IoT device belonging to the set of IoT devices.

An IoT device may be configured to receive a group discovery query for a set of IoT devices. The group may be based on at least one of (a) an IoT device class, (b) a measurement type, (c) a data priority, (d) a type of information carried by the set of IoT devices, (e) a presence of data, (f) an amount of the data, (g) a distance from a radio frequency (RF) source device, or (h) a set of identifiers for the one or more IoT devices in the group. The IoT device may be configured to transmit a response to the group discovery query based on the IoT device belonging to the set of IoT devices.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media may include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

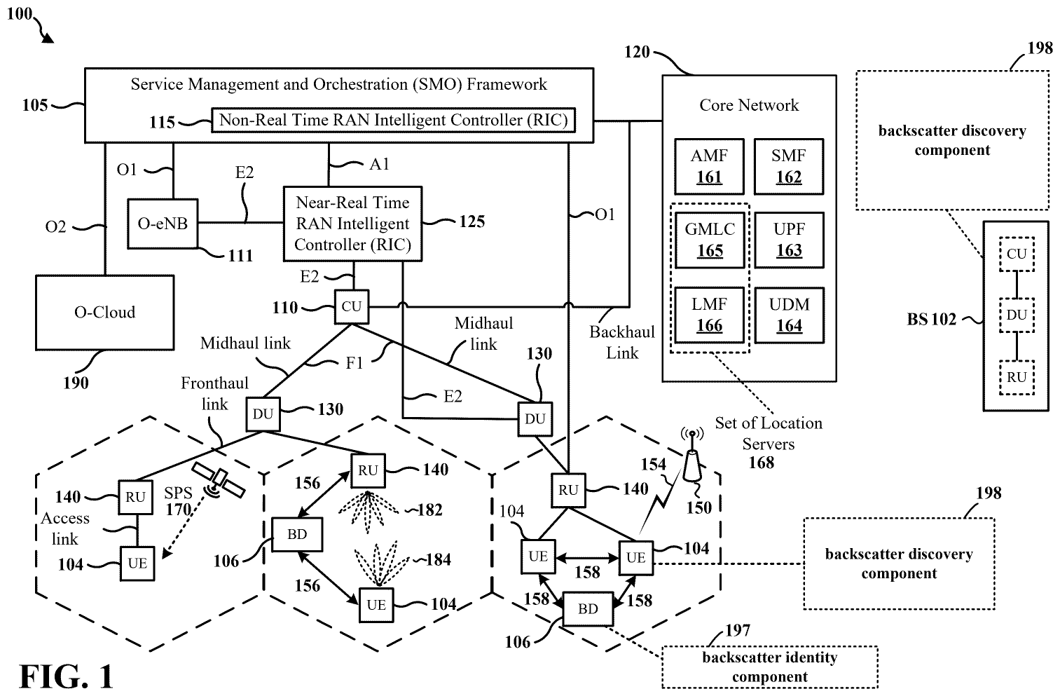

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

One or more wireless signals may be relayed to another device via an IoT device 106 via a radio frequency (RF) link, such as the D2D communication link 158 or a universal mobile telecommunications system (UMTS) terrestrial radio access (UTRA) (Uu) link 156. In one aspect, a UE 104 may communicate with another UE 104 via an IoT device 106 that may be configured to backscatter a signal received via a D2D communication link 158. In another aspect, an RU 140 may communicate with a UE 104 via an IoT device 106 that may be configured to backscatter a signal received via the Uu link 156. The IoT device 106 may backscatter a signal from the UE 104 to the RU 140, or may backscatter a signal from the RU 140 to the UE 104. In some aspects, the IoT device 106 may backscatter a signal back to the source device, such as from the UE 104 to the same UE 104 or from the RU 140 to the same RU 140. The backscattered signal using the D2D communication link 158 or the Uu link 156 may include a superposition of both a direct link signal and a backscatter signal from the source device.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects the IoT device 106 may have a backscatter identity component 197 configured to receive a group discovery query for a set of IoT devices. The group may be based on at least one of (a) an IoT device class, (b) a measurement type, (c) a data priority, (d) a type of information carried by the set of IoT devices, (e) a presence of data, (f) an amount of the data, (g) a distance from a radio frequency (RF) source device, or (h) a set of identifiers for the one or more IoT devices in the group. The backscatter identity component 197 may be configured to transmit a response to the group discovery query based on the IoT device belonging to the set of IoT devices. In certain aspects, the UE 104 or the base station 102 may be configured to have a backscatter discovery component 198 configured to transmit a group discovery query for a set of IoT devices. The group may be based on at least one of (a) an IoT device class, (b) a measurement type, (c) a data priority, (d) a type of information carried by the set of IoT devices, (e) a presence of data, (f) an amount of the data, (g) a distance from a radio frequency (RF) source device, or (h) a set of identifiers for the one or more IoT devices in the group. The backscatter discovery component 198 may be configured to receive a response to the group discovery query from an IoT device belonging to the set of IoT devices. Although the following description may be focused on RFID tags, the concepts described herein may be applicable to any device configured to backscatter wireless signals.

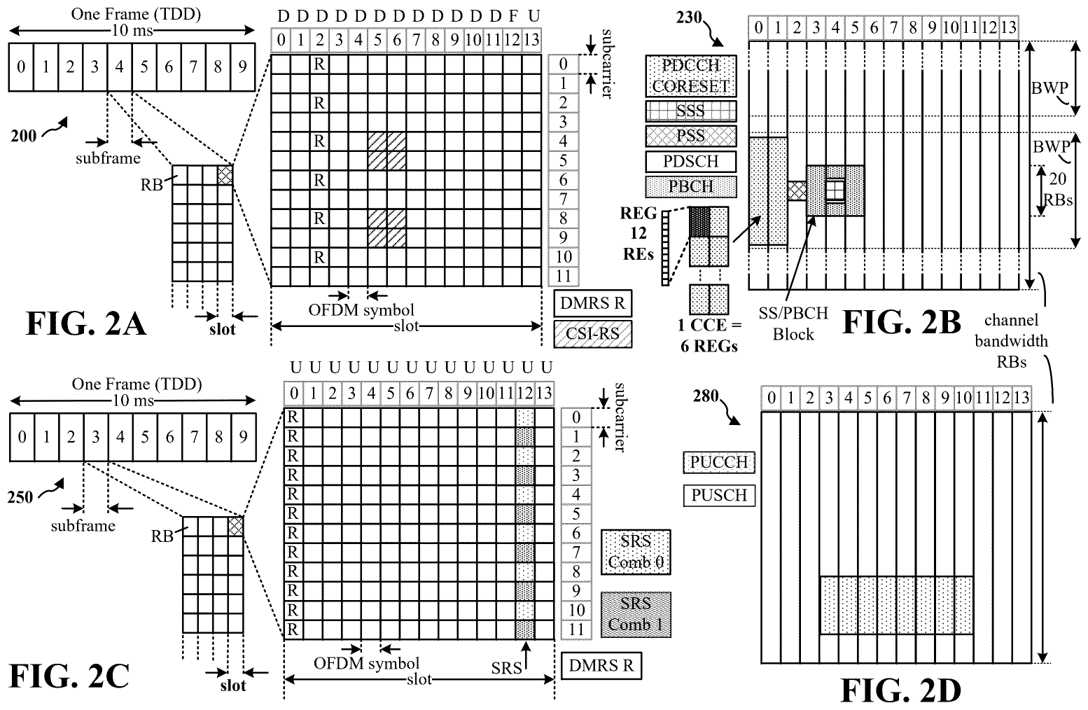

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology ∪, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

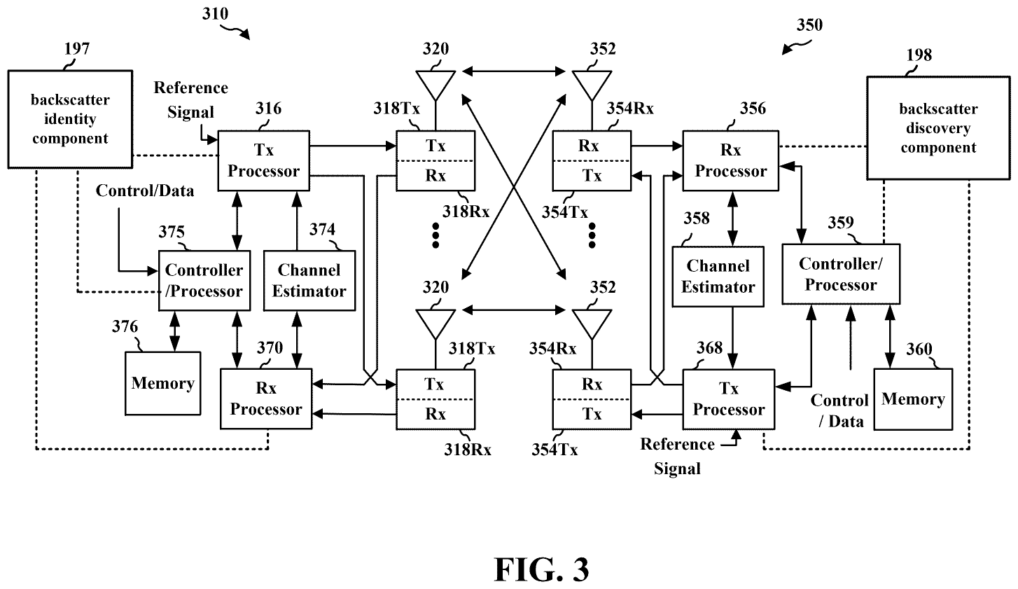

FIG. 3 is a block diagram of an IoT device 310 in communication with a wireless device 350 in an access network. The wireless device 350 may be, for example, the UE 104 or the base station 102 in FIG. 1. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the wireless device 350. Each spatial stream may then be provided to a different antenna 320 via a separate transmitter 318Tx. Each transmitter 318Tx may modulate a radio frequency (RF) carrier with a respective spatial stream for transmission.

At the wireless device 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the wireless device 350. If multiple spatial streams are destined for the wireless device 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal may include a separate OFDM symbol stream for each subcarrier of the OFDM signal. The symbols on each subcarrier, and the reference signal, are recovered and demodulated by determining the most likely signal constellation points transmitted by the IoT device 310. These soft decisions may be based on channel estimates computed by the channel estimator 358. The soft decisions are then decoded and deinterleaved to recover the data and control signals that were originally transmitted by the IoT device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the IoT device 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the IoT device 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the IoT device 310 in a manner similar to that described in connection with the receiver function at the wireless device 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the backscatter discovery component 198 of FIG. 1.

At least one of the Tx processor 316, the Rx processor 370, and the controller/processor 375 may be configured to perform aspects in connection with the backscatter identity component 197 of FIG. 1.

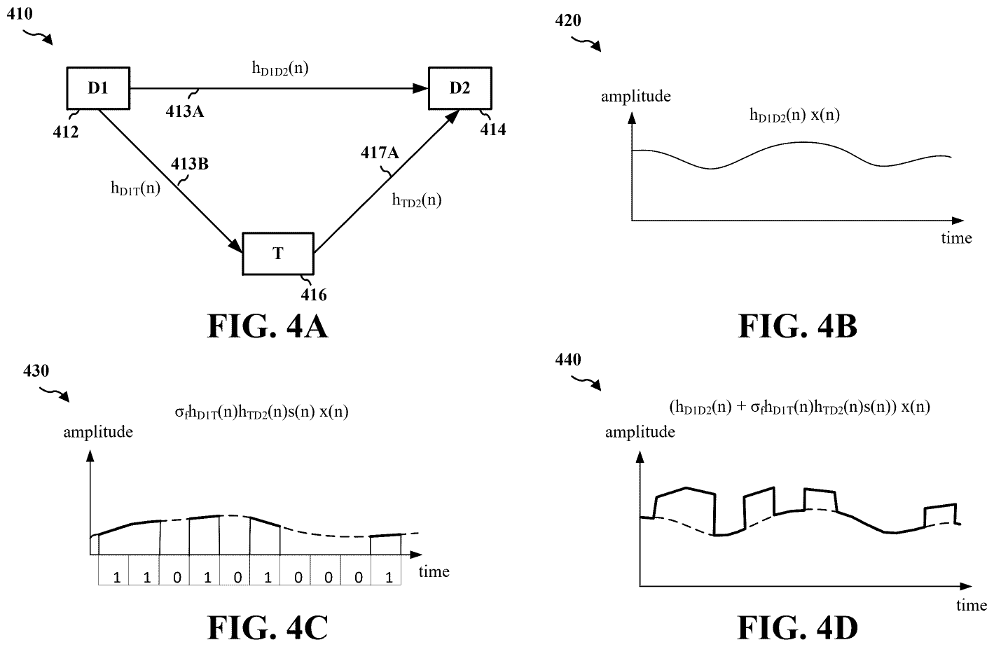

FIG. 4A is a diagram 410 illustrating an example of a wireless communications system having an RF source 412 shown as device D1, an RF reader 414 shown as device D2, and an IoT device (IoTD) 416 shown as a tag T that may reflect or backscatter a signal 413B from the RF source 412 as a signal 417A to the RF reader 414. The IoTD 416 may be a passive IoT device. In some aspects, the IoTD 416 may be a zero power IoTD (ZP-IoTD), a zero power personal IoTD (ZP-PIOTD), an ambient IoT device, etc. An RF source 412 or the RF reader 414 may be, for example, a UE, a base station, or a component of a base station. The RF reader 414 may monitor the IoTD 416 responses as the signal 417A and may also monitor the commands/queries sent to the IoTD 416 as the signal 413A to determine and adjust potential configurations and track time allocations, frequency allocations, and configurations to decode responses from the IoTD 416. The RF source 412 may transmit a signal 413A to the RF reader 414. The RF source 412 may also transmit a signal 413B to the IoTD 416. The signal 413A and the signal 413B may be the same signal received contemporaneously by both the RF reader 414 and the IoTD 416. In other words, the RF source 412 may be considered an RF source for both the signal 413A and the signal 413B. The RF source 412 may transmit a continuous wave (CW), such as a sine wave. While the RF source 412 and the RF reader 414 are depicted as two separate devices in the diagram 410, the RF source 412 and the RF reader 414 may be a full duplex (FD) UE that reads a reflected or backscattered signal from the IoTD 416.

The IoTD 416 may reflect or backscatter the signal 413B as signal 417A to the RF reader 414. If the IoTD 416 reflects the signal 413B as signal 417A to the RF reader 414, the signal 417A from the IoTD 416 to the RF reader 414 may reinforce the signal 413A from the RF source 412 to the RF reader 414, strengthening the signal received by the RF reader 414. If the IoTD 416 backscatters the signal 413B as signal 417A to the RF reader 414, the signal 417A from the IoTD 416 to the RF reader 414 may include an embedded signal (i.e., information bits) from the backscattering-based communications device in addition to the signal received by the RF reader 414. In other words, the IoTD 416 may modulate the signal 413B with its data sequence. The RF source 412 may send one or more queries to the IoTD 416, and the IoTD 416 may respond to one or more queries by transmitting a re-modulated signal as the signal 417A. The IoTD 416 may transmit the signal 417A using any suitable resources, such as a CW resource. The CW resource may have a CW configuration having a single tone waveform, a multi-tone waveform, an OFDM waveform, or a single carrier (SC) waveform. The SC waveform may be, for example, a single carrier quadrature amplitude modulation (SC-QAM) waveform or a discrete Fourier transform spread orthogonal frequency division multiplexing (DFT-s-OFDM) waveform. The CW configuration may include at least one of a time, a frequency, a type of waveform, a type of modulation (e.g., Manchester coding, pulse-position modulation (PPM), pulse-width modulation (PWM), pulse-code modulation (PCM), chirp-based modulation, amplitude-shift keying (ASK), on-off keying (OOK), discrete Fourier transform (DFT), four-wave mixing (FWM)), or a type of coding (e.g., repetition, forward-error-correction, polar, low-density parity check (LDPC)).

The IoTD 416 may be a passive, an active, a semi-passive, or a semi-active IoT device. A passive IoT device may include an energy harvesting (EH) device configured to opportunistically harvest energy in the environment, such as solar, heat, and ambient RF. Such an EH device may have protocol enhancements that support one or more operations using intermittently available energy harvested from the environment. The passive IoT device may store harvested energy using a power storage unit, such as a capacitor or a supercapacitor, which may power RF components, such as the IC, an analog-to-digital converter (ADC), a mixer, and/or an oscillator. The passive IoT device may not have a battery. Variations on the amount of harvested energy and traffic may be expected using such devices. Passive IoT devices that operate using intermittently available energy harvested from the environment may not be able to sustain long, continuous transmission and/or reception. A semi-passive IoT device may have any of the capabilities of a passive IoT device, and may also have a power storage unit, such as a supercapacitor or a battery, that may power and/or turn on an IC of the device. A semi-passive IoT device may also reflect or backscatter an incident signal received by the passive IoT device. The IoTD 416 may be a UE, such as the UE 104 in FIG. 1, that may contain an RFID tag radio or a backscattering-based communications radio. The UE may be configured to use the radio to communicate signals. In one aspect, a UE may be configured to use such a radio instead of an antenna to communicate in response to a condition, for example if the UE is in a low power state, or if the UE is configured to use less power for a task. In another aspect, a UE may provide its capability of using such a radio to communicate signals to a network node, for example a base station, and the network node may configure the UE to use such a radio for communications based on a schedule (e.g., during periodic times, scheduled times, or in response to a trigger indicated by the network node).

A semi-active IoT device may have any of the capabilities of a passive or a semi-passive IoT device, and may also use its power storage unit to strengthen a received signal, for example by using a power amplifier (PA) that increases an amplitude of the reflected or backscattered signal. An active IoT device may have a power storage unit, such as a battery, that may provide power to one or more active RF components to transmit a signal even when the active IoT device is not within range to receive a signal. An active RF component may strengthen a received signal, for example by using a power amplifier (PA) that increases an amplitude of the reflected or backscattered signal. An active IoT device may even provide a reflected or backscattered signal that is stronger than the signal received by the device, such as the signal 413B received by the IoTD 416. An active IoT device may also use its power storage unit to transmit a signal generated by the active IoT device that is not a reflected or a backscattered signal.

The IoTD 416 may modulate an incident wave and/or signal using a data sequence. For example, the IoTD 416 may use an amplitude shift keying (ASK) modulation method to switch on a reflection when transmitting an information bit “1” and switch off the reflection when transmitting an information bit “0.” For example, FIG. 4B is a diagram 420 illustrating an example of a radio wave transmitted by a wireless communications device, such as the RF source 412 in FIG. 4A. FIG. 4C is a diagram 430 illustrating an example of a backscattered signal where the backscattering-based communications device, such as the IoTD 416 in FIG. 4A, switches on a reflection when transmitting an information bit “1” and switches off the reflection when transmitting an information bit “0.” FIG. 4D is a diagram 440 illustrating an example of a signal received at a UE, such as the RF reader 414 in FIG. 4A, which may be a combination of a radio wave transmitted by a wireless communications device, such as the RF source 412 in FIG. 4A, and a radio wave transmitted by a backscattering-based communications device, such as the IoTD 416 in FIG. 4A.

Each radio wave may be denoted as x(n), such that h_{DID2}(n) represents a radio wave from the RF source 412 to the RF reader 414, h_{DIT}(n) represents a radio wave from the RF source 412 to the IoTD 416, and h_{TD2}(n) represents a radio wave from the IoTD 416 to the RF reader 414. Diagram 420 in FIG. 4B shows a radio wave h_{D1D2}(n) representing a radio wave x(n) transmitted by the RF source 412 in FIG. 4A. The RF reader 414 may receive the radio wave as the signal 413A, denoted as h_{D1D2}(n), and the IoTD 416 may receive the radio wave as the signal 413B, denoted as h_{D1T}(n).

The IoTD 416 may use an ASK modulation method to switch on a reflection when transmitting an information bit “1” and switch off the reflection when transmitting an information bit “0.” The information bits of the IoTD 416 may be denoted as s(n)∈{0,1}. Diagram 430 FIG. in 4C shows a radio wave σ_{f}h_{D1T}(n)h_{TD2}(n)s(n) representing a backscattered radio wave of the radio wave in diagram 420 in FIG. 4B, where the IoTD 416 in FIG. 4A switches on reflection when transmitting an information bit “1” and switches off reflection when transmitting an information bit “0.” σ_{f} may denote the reflection coefficient of the IoTD 416. s(n) may represent the backscattered signal from IoTD 416 that reflects the signal from the RF source 412. The IoTD 416 may transmit the radio wave as the signal 417A, denoted as h_{TD2}(n), to the RF reader 414.

The RF reader 414 in FIG. 4A may receive a combination of the signal 413A, shown as the radio wave h_{D1D2}(n) in FIG. 4B, and the signal 417A, shown as the radio wave σ_{f}h_{D1T}(n)h_{TD2}(n)s(n) in FIG. 4C. Diagram 440 in FIG. 4D shows a radio wave h_{D1D2}(n)+σ_{f}h_{D1T}(n)h_{TD2}(n)s(n) representing the combination of the radio wave=h_{D1D2}(n) of diagram 410 in FIG. 4B and the radio wave σ_{f}h_{D1T}(n)h_{TD2}(n)s(n) of diagram 420 in FIG. 4C. The RF reader 414 may then decode the combination radio wave to read the transmission from the RF source 412, and also read information bits from the IoTD 416. In other words, the RF reader 414 may estimate the envelope of the signal 417A, and the envelope may represent information bits from the IoTD 416.

The complete signal received by the RF reader 414 in FIG. 4A may be represented by h_{D1D2}(n)+σ_{f}h_{D1T}(n)h_{TD2}(n)s(n)+noise, where noise represents signals received from other wireless devices using resources that overlap the transmissions from the RF source 412 and the IoTD 416. When s (n)=0, the IoTD 416 may switch off reflection, so that the RF reader 414 may receive the signal 413A via a direct link from the RF source 412, represented by h_{D1D2}(n)+noise. When s(n)=1, the IoTD 416 may switch on reflection, so that the RF reader 414 receives the superposition of both the direct link signal as signal 413A from the RF source 412 and the backscatter link signal as signal 417A from the IoTD 416, represented by h_{D1D2}(n)+σ_{f}h_{D1T}(n)h_{TD2}(n)s(n)+noise.

The superposition of a direct link signal from a UE and a backscattered signal from a low-power backscattering-based communications device may not be significantly different from the direct link signal alone since the backscattered signal may be far weaker than the direct link signal (e.g., a backscattered CW signal may be 4× weaker than a direct link CW signal). For example, if the distance between the RF source 412 in FIG. 4A and the IoTD 416 is 10 m, and the distance between the IoTD 416 and the RF reader 414 is 10 m, then the power difference between the signal 413A and the signal 417A may be 16 dB. If the distance between the RF source 412 in FIG. 4A and the IoTD 416 is 20 m, and the distance between the IoTD 416 and the RF reader 414 is 20 m, then the power difference between the signal 413A and the signal 417A may be 30 dB.

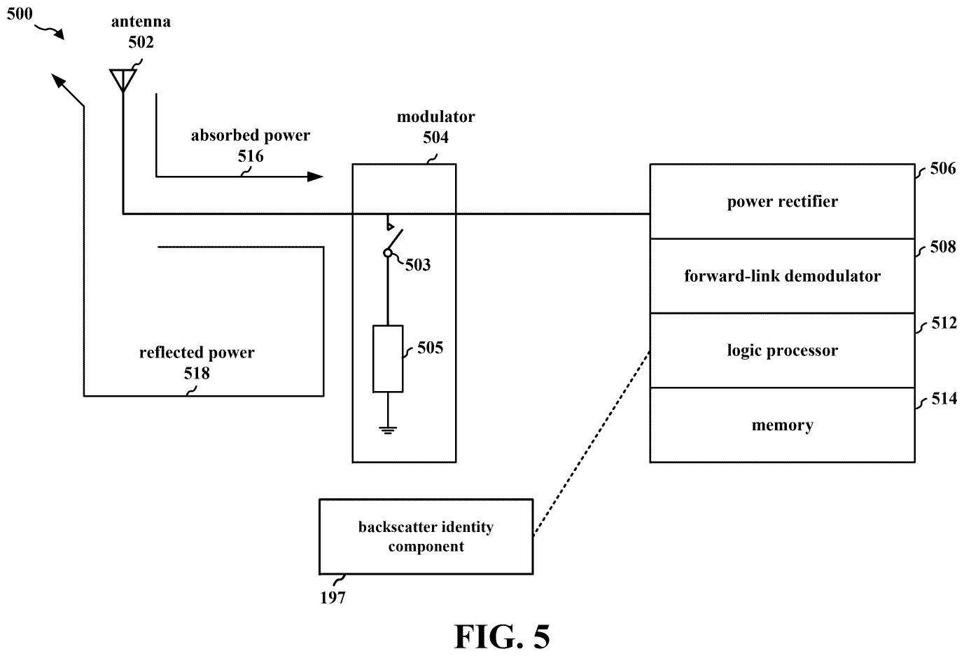

FIG. 5 illustrates a diagram 500 of a passive IoT device with an antenna 502 that absorbs power 516 and reflects power 518. The antenna 502 may absorb power 516 from an incoming signal, such as a sidelink signal or a Uu signal, which may be used to power the IoT device. The power may be used by the IoT device to perform functionality, such as rectifying and modulation. The modulator 504 may be an amplitude shift keying (ASK) or a phase shift keying (PSK) modulator having a switch 503 that may switch the IoT device between a power absorption mode and a power reflection mode. When the switch 503 is off (open), the power 516 from the antenna 502 may be directed to the power rectifier 506, which may rectify a continuous wave (CW) input signal into a DC current for the IoT device. In other words, the power rectifier 506 may change an AC input signal into a DC signal for use to provide power to a power source, such as a capacitor or a battery. In some aspects, the power rectifier 506 may include a diode and a battery. The input signal may also be provided to the forward-link demodulator 508, which may demodulate the input signal to read an instruction, such as a query or a command to the IoT device. The demodulated signal may be processed by a logic processor 512 of the IoT device. The logic processor 512 may be associated with a memory 514 that stores program codes and data. The memory 514 may be referred to as a computer-readable medium.

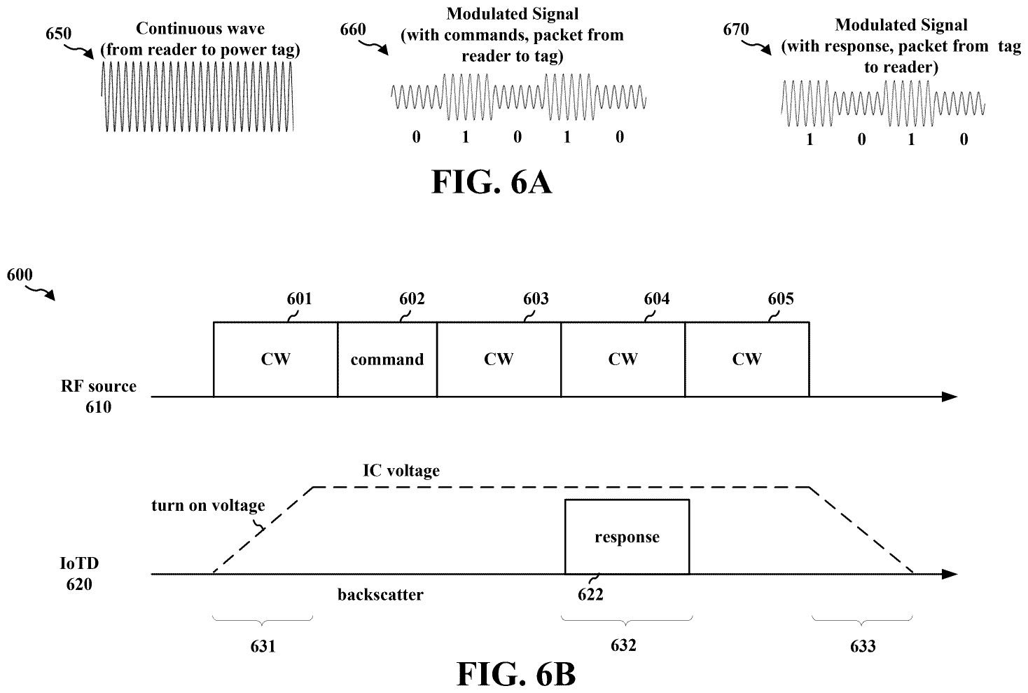

When the switch 503 is on (closed), the power 518 may be reflected by the modulation component 505, which may transmit information bits in the power 518 that is reflected by the IoT device. For example, the modulation component 505 may switch on a reflection when transmitting an information bit “1” and switch off the reflection when transmitting an information bit “0.” FIG. 6A illustrates an example of a continuation wave at 650 that a reader may transmit to power an IoT device, such as a tag. FIG. 6A illustrates an example of a modulated signal 660 that a reader may transmit to an IoT device, such as a tag, and that may include a command or packet for the IoT device. FIG. 6A illustrates an example of a modulated signal 670 that may be transmitted as a response from the IoT device to the reader. In some aspects, an IoT device may have a battery that may provide power when there is not enough absorbed power to power the IoT device. The logic processor 512 may be configured to perform aspects in connection with the backscatter identity component 197 of FIG. 1.

As discussed supra, the backscatter identity component 197 may be configured to receive a group discovery query for a set of IoT devices. The group may be based on at least one of (a) an IoT device class, (b) a measurement type, (c) a data priority, (d) a type of information carried by the set of IoT devices, (e) a presence of data, (f) an amount of the data, (g) a distance from a radio frequency (RF) source device, or (h) a set of identifiers for the one or more IoT devices in the group. The backscatter identity component 197 may be configured to transmit a response to the group discovery query based on the IoT device belonging to the set of IoT devices. The backscatter identity component 197 may be within one or more processors of one or more of the logic processor 512. The backscatter identity component 197 may be one or more hardware components specifically configured to carry out the stated processes/algorithm, implemented by one or more processors configured to perform the stated processes/algorithm, stored within a computer-readable medium for implementation by one or more processors, or some combination thereof. The IoT device may include a variety of components configured for various functions. In one configuration, the IoT device includes means for transmitting a group discovery query for a set of IoT devices. The IoT device may include means for receiving a response to the group discovery query from an IoT device belonging to the set of IoT devices. The IoT device may include means for transmitting, prior to the group discovery query, a configuration indicating the resource for IoT devices without the established ID with the RF source device. The IoT device may include means for transmitting, in the group discovery query, an indication of the resource for IoT devices without the established ID with the RF source device. The IoT device may include means for transmitting, after receipt of the response, an additional transmission including one or more of (a) an indication to use a new ID or to continue using a prior ID used in the response to the group discovery query, (b) first timing information for an additional query, (c) resource information for the additional query, (d) a continuous wave configuration for the additional query, (e) second timing information for the IoT device, (f) a request for class information from the IoT device, (g) data from a radio frequency source, (h) the additional query for the IoT device, or (i) a command for the IoT device. The IoT device may include means for exchanging data with the IoT device based on at least one of (a) indicated data resources corresponding to an RFID device, (b) a resource mapped to the resource for sending an identifier for the IoT device, (c) the IoT device class, (d) a measurement of a signal carrying the group discovery query, (e) the data priority for transmission by the IoT device, (f) a quality of service of the data for the transmission by the IoT device, (g) the amount of the data for the transmission by the IoT device, (h) the IoT device not having an established ID with the RF source device, (i) a unique ID (UID) for the IoT device (e.g., a hardware ID), (j) a password associated with the IoT device, (k) a Zone ID, (l) a configuration parameter of the group discovery query, (m) a beam ID, (n) an RF source ID, or (o) an RF reader ID. The IoT device may include means for transmitting one or more beams. The method may include receiving, from the IoT device, a measurement report for the one or more beams indicating at least one of an RF source ID, a beam ID, a cell ID, or an RF reader ID. The measurement report may be transmitted to be to transmitted to an RF source, an RF reader, a network unit/node/entity (which may be part of RF source or RF reader or may not be a part of the RF source or RF reader), another UE (e.g., a UE not involved as an RF source or RF reader), or a base station such as a gNB (which may be part of RF source or RF reader or may not be a part of the RF source or RF reader), among other examples. The means may be the backscatter identity component 197 of the IoT device configured to perform the functions recited by the means. As described supra, the IoT device may include the logic processor 512. As such, in one configuration, the means may be the logic processor 512 configured to perform the functions recited by the means.

FIG. 6B shows a diagram 600 of an example of a backscatter communication timeline between an RF source 610 and an Internet-of-things device (IoTD) 620 that uses power from an incoming transmission to power the IoTD 620. The IoTD 620 may be a passive IoT device. In some aspects, the IoTD 620 may be a zero power IoTD (ZP-IoTD) or a zero power personal IoTD (ZP-PIOTD). The RF source 610 may be, for example, the UE 104 or the base station 102 in FIG. 1, a network unit/node/entity (e.g., RAN node, relay node, IAB node, etc). The IoTD 620 may be, for example, the IoT device 106 in FIG. 1. When a signal is not being transmitted to the IoTD 620, the IoTD 620 may be in idle mode. When the IoTD 620 is in idle mode, the IoTD 620 may use an incoming transmission to power the device.

The RF source 610 may transmit a CW signal 601 during the time period 631. The time period 631 may be greater or equal to 400 μS. The CW signal 601 may be used to turn on the voltage at the IoTD 620. Power from the CW signal 601 may be directed to one or more capacitors of the IoTD 620 to activate components of the IoTD 620, such as an integrated circuit (IC) or a demodulator. After a threshold period of time, for example at least 400 μS, the IoTD 620 may have collected enough voltage to be powered up and able to receive an instruction from the RF source 610.

The RF source 610 may transmit a command 602 to the IoTD 620. The command 602 may provide both information and power to the IoTD 620. Information in the form of a signal having an instruction for the IoTD 620 to implement, and power in the form of a received RF signal that may be passed through a rectifier to provide power for the IoTD 620. The command 602 may have a signal strength greater or equal to a threshold value, such as −20 dBm, to provide both information and power to the IoTD 620.

The RF source 610 may continue to provide a CW signal 603 to maintain the power level of the IoTD 620. The CW signal 603 may have a signal strength greater or equal to a threshold value to ensure that the IC chip of the IoTD 620 remains turned on to process the command 602 received earlier. The IoTD 620 may transmit a response 622 during the time period 632 to a reader device. The reader device may be the RF source 610 (e.g., in a monostatic system), or the reader device may be a different wireless device (e.g., in a bistatic system). The reader device may be a unit, relay, entity that supports reception of the signal from the IoTD. The RF source 610 may continue to provide a CW signal 604 to maintain the power level of the IoTD 620. The CW signal 604 may have a signal strength greater or equal to a threshold value to ensure that the IC chip of the IoTD 620 remains turned on during the time period 632. The CW signal 604 may be used both to provide power to the IoTD 620 and to provide a carrier wave for tag modulation at the IoTD 620. In other words, the response 622 may be a reflected signal of the CW signal 604, which has the response modulated with the reflected signal, similar to the combination signal shown in diagram 440 in FIG. 4D.

The RF source 610 may continue to provide a CW signal 605 to maintain the power level of the IoTD 620. The CW signal 605 may have a signal strength greater or equal to a threshold value to ensure that the IC chip of the IoTD 620 remains turned on. The RF source 610 may stop transmitting a CW signal during the time period 633. During the time period 633, the voltage of the IoTD 620 may drop and it may once again be switched to idle mode to remain dormant until a signal is transmitted to the IoTD 620 to power it up again.

In some aspects, an RF source may have one or more IoT devices within its vicinity. In other words, when the RF source transmits an RF signal, more than one IoT devices may receive the RF signal. The RF source may attempt to discover nearby IoT devices by transmitting a discovery request. In some aspects, the discovery request may include a request for an identifier (ID). Once the RF source receives information, such as an ID, from an IoT device, the RF source may communicate with such devices using the IDs received from the IoT devices. When the RF source attempts to discover IoT devices at a later time, some of the IoT devices may be devices that the RF source previously communicated with (e.g., an established IoT device), and other IoT devices may be devices that the RF source has not previously communicated with (e.g., a new IoT device) or for which a duration of time has passed since communication between the RF source and the IoT device (e.g., an expired IoT device). The RF source may save time and resources by configuring new IoT devices at this time and retrieving data about recently configured IoT devices and/or expired IoT devices from its memory. An IoT device may be referred to as a tag, or an RFID tag.

An RF source, such as a base station or a UE, may be configured to discover, identify, or otherwise determine nearby IoT devices during a first time period, and may configure discovered IoT devices so that the RF source may communicate with the nearby IoT devices, for example by transmitting a command or query to the IoT device. An IoT device may be, for example, an RFID tag device, a backscattering-based communications device, a UE configured to communicate with an RFID tag device, or a UE configured to communicate with a backscattering-based communications device. An IoT device that the RF source has configured to communicate with may be referred to as an old IoT device, a known IoT device, an established IoT device, or an IoT device with an established ID. The RF source may discover nearby IoT devices during a second time period, and configure newly discovered IoT devices so that the RF source may communicate with the newly discovered IoT devices. A newly discovered IoT device with respect to the RF source may also be referred to as an unknown IoT device, a non-established IoT device, or an IoT device without an established ID. In some aspects, an IoT device that the RF source has not communicated with for a period of time may no longer be considered as an established IoT device, and may be referred to as an expired IoT device or an IoT device with an expired ID. Such IoT devices may also be considered newly discovered with respect to the RF source. The RF source may use saved configuration data (e.g., an established ID) associated with the known IoT devices and may use the saved configuration data (such as the established ID) to communicate with the known IoT devices around the RF source. The discovery procedure may be viewed as a radio frequency identifier (RFID) tag random-access channel (RACH) procedure that is triggered by the RF source. The RF source may allow configurations to expire. In some aspects, after a timer associated with a known IoT device expires, the RF source may treat the expired IoT device as an unknown or new IoT device during a subsequent discovery process. The RF source may use at least one of a beam ID, a cell ID, an RF source ID, an IoT device class, a or an IoT device ID to determine a first IoT device that may serve a second IoT device (e.g., reading from the first IoT device and writing to the second IoT device). An IoT device may also report a radio resource management (RRM) measurement or one or more beams/RF source pairs observed by the IoT device. The report may be periodic or may be transmitted upon request. The IoT device may report the best beam/RF source pair observed by the IoT device.

A wireless device configured to discover IoT devices may be configured to transmit a group discovery query for a set of IoT devices. The group may be based on at least one of (a) an IoT device class, (b) a measurement type, (c) a data priority, (d) a type of information carried by the set of IoT devices, (e) a presence of data, (f) an amount of the data, (g) a distance from a radio frequency (RF) source device, or (h) a set of identifiers for the one or more IoT devices in the group. The wireless device may be configured to receive a response to the group discovery query from an IoT device belonging to the set of IoT devices.

An IoT device may be configured to receive a group discovery query for a set of IoT devices. The group may be based on at least one of (a) an IoT device class, (b) a measurement type, (c) a data priority, (d) a type of information carried by the set of IoT devices, (e) a presence of data, (f) an amount of the data, (g) a distance from a radio frequency (RF) source device, or (h) a set of identifiers for the one or more IoT devices in the group. The IoT device may be configured to transmit a response to the group discovery query based on the IoT device belonging to the set of IoT devices.

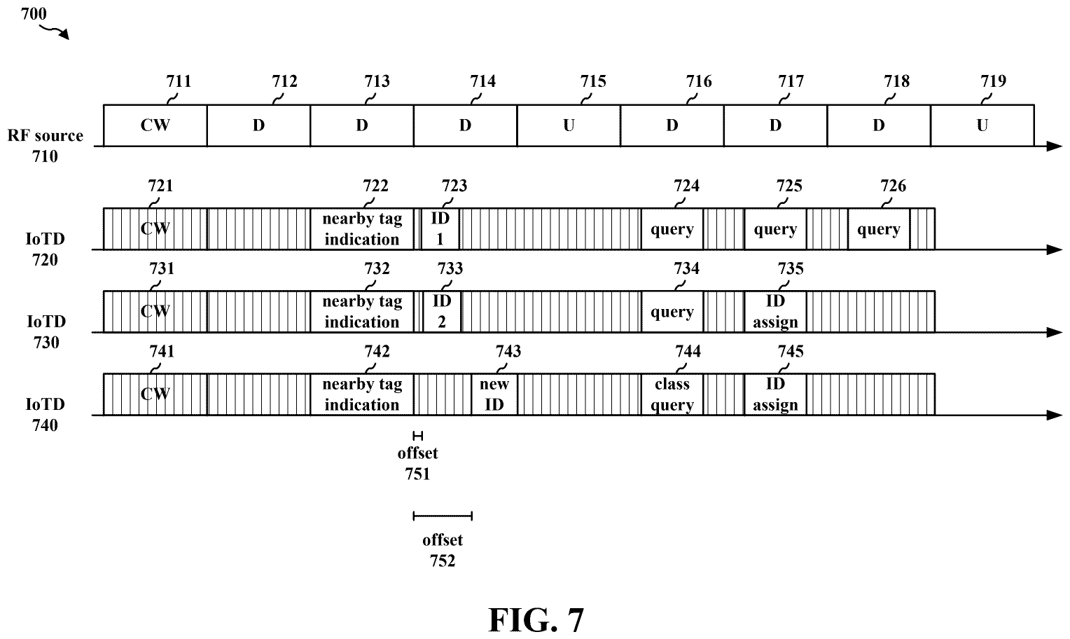

FIG. 7 shows a diagram 700 of another example of a backscatter communication timeline between an RF source 710 and a plurality of IoTDs 720, 730, and 740. IoTDs 720 and 730 may be established IoT devices that the RF source 710 has communicated with, or whose information is saved in a memory of the RF source 710, and IoTD 740 may be a new IoT device that the RF source 710 has not communicated with, or whose information is not saved in a memory of the RF source 710. The RF source 710 may be configured to transmit a CW signal at time occasions 711, 712, 713, 714, 715, 716, 717, 718, and 719 to ensure that an IoT device that receives the CW stays activated. At time occasion 715 or time occasion 719, the RF source 710 may be configured to communicate with another wireless device, such as a base station or a UE. At time occasions 712, 713, 714, 716, 717, and 718 the CW source may be configured to communicate with one or more IoT devices, such as the IoTDs 720, 730, and 740. The time occasions 712, 713, 714, 716, 717, and 718 may also be referred to as response occasions. An IoT device may be configured to backscatter a received CW signal during the response occasions, such as the time occasions 712, 713, 714, 716, 717, and 718.

The IoTD 720 may be an established IoT device that has been configured by the RF source 710 to respond to commands from the RF source 710. At 721, the IoTD 720 may receive a CW signal from the RF source 710 to turn on the voltage at the IoTD 720. At 722, the IoTD 720 may transmit an indication that it is a nearby tag to devices around it, such as the RF source 710 or another wireless device, such as a UE or a base station. At 723, the IoTD 720 may transmit an ID associated with the IoTD 720. The ID may be an ID assigned to the IoTD 720. In some aspects, the IoTD 720 may transmit a plurality of IDs at 723, where each ID includes and ID assigned to the IoTD 720 by a different RF source. The IoTD 720 may transmit an ID after a time offset 751, which may be associated with a class of the IoTD 720. The time offset may be configured by an RRC configuration. The RF source 710 may receive the nearby tag indication at 722 and the ID at 723, and recognize that the IoTD 720 is an established device. The RF source 710 may then communicate with the IoTD 720 at 724, 725, and 726, for example by transmitting queries or commands to the IoTD 720.

The IoTD 730 may be an established IoT device that has not communicated with the RF source 710 for a threshold period of time. In other words, the IoTD 730 may be an expired IoT device with respect to the RF source 710. At 731, the IoTD 730 may receive a CW signal from the RF source 710 to turn on the voltage at the IoTD 730. At 732, the IoTD 730 may transmit an indication that it is a nearby tag to devices around it, such as the RF source 710 or another wireless device, such as a UE or a base station. At 733, the IoTD 730 may transmit an ID associated with the IoTD 730. The ID may be an ID assigned to the IoTD 730. The IoTD 730 may transmit an ID after a time offset 751, which may be associated with a class of the IoTD 730. The class of the IoTD 730 may be the same as the class of the IoTD 720, such that the IoTD 720 and the IoTD 730 may transmit an ID after the same time offset. The time offset may be configured by an RRC configuration. The RF source 710 may receive the nearby tag indication at 732 and the ID at 733, and recognize that the IoTD 730 is an expired IoT device. In some aspects, the RF source 710 may have some information associated with the IoTD 730 saved in a memory, and may not need to transmit a query at 734 to the IoTD 730 to gain information, such as a hardware ID or a location indicator, that may be used to configure the IoTD 730. In other aspects, the RF source 710 may have some information associated with the IoTD 730, but may not have other information associated with the IoTD 730 and may transmit a query at 734 to the IoTD 730 to gain partial information, such as a location indicator but not a hardware ID, from the IoTD 730. In other aspects, the RF source may not have information associated with the IoTD 730, as such information may have been deleted or otherwise purged upon expiration, and the RF source 710 may transmit a query at 734 to the IoTD 730 to gain new information, such as a hardware ID and a location identifier, from the IoTD 730. At 735, the RF source 710 may assign a new ID or the same ID to the IoTD 730. Assigning the ID to the IoTD 730 may reset an expiration timer associated with the IoTD 730. The RF source 710 may then communicate with the IoTD 730 using the ID assigned at 735.

The IoTD 740 may be a new IoT device that has never communicated with the RF source 710. In other words, the IoTD 740 may be a new IoT device with respect to the RF source 710. At 741, the IoTD 740 may receive a CW signal from the RF source 710 to turn on the voltage at the IoTD 740. At 742, the IoTD 740 may transmit an indication that it is a nearby tag to devices around it, such as the RF source 710 or another wireless device, such as a UE or a base station. At 743, the IoTD 740 may transmit an ID, such as a new ID a UID, or an unallocated ID. The IoTD 740 may transmit an ID after a time offset 752, which may be associated with a class of the IoTD 740. The class of the IoTD 740 may be different than the class of the IoTD 720 and the class of the IoTD 730, such that the IoTD 740 may transmit an ID after a different time offset than the IoTD 720 and the IoTD 730. The time offset may be configured by an RRC configuration. The RF source 710 may receive the nearby tag indication at 742 and the ID at 743, and recognize that the IoTD 740 is a new IoT device with respect to the IoTD 740. At 744, the RF source 710 may query the IoTD 740 about its class or about other information that the RF source 710 may use to configure the IoTD 740. At 745, the RF source 710 may assign an ID to the IoTD 740, or may reverify that a chosen unallocated ID transmitted at 743 is accepted by the RF source 710. The RF source 710 may then communicate with the IoTD 740 using the ID assigned at 745.

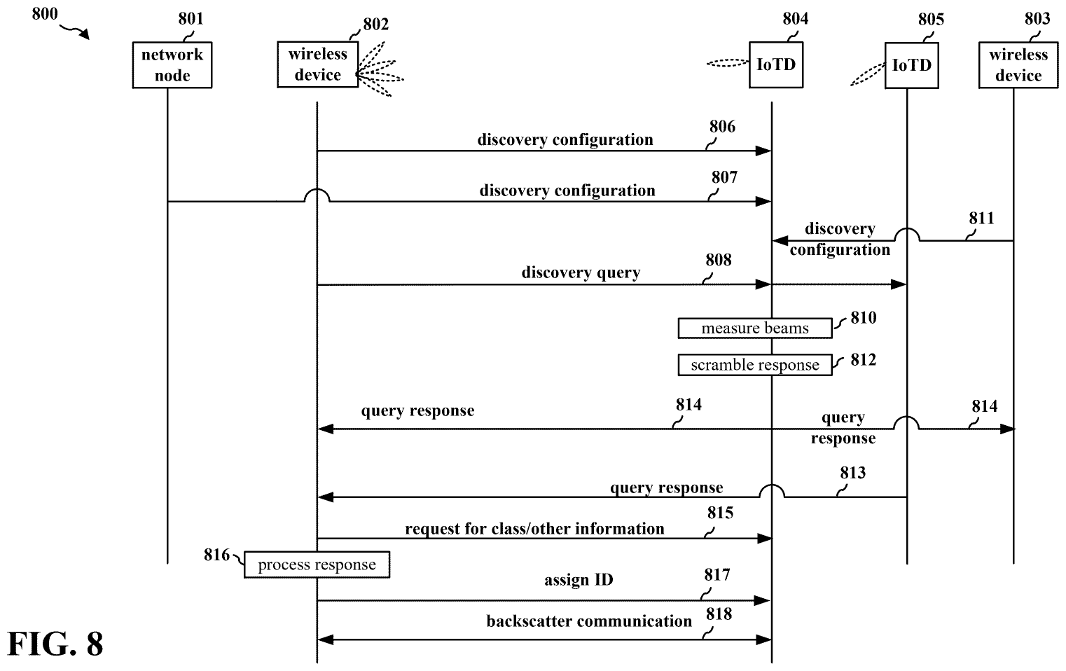

FIG. 8 is a communication flow diagram 800 illustrating a wireless device 802 and multiple IoT devices, e.g., including an IoTD 804 and an IoTD 805, configured to communicate with one another in a monostatic mode. While one wireless device and two IoT devices may be shown in communication flow diagram 800, the wireless device 802 may transmit and receive data with any number of IoT devices in other aspects. In one aspect, the wireless device 802 may transmit a discovery query 808 to the IoTD 804, and wireless device 802 may receive the query response 814 from the IoTD 804 in a monostatic configuration. In such a configuration, the wireless device 802 may be considered both the RF source and the RF receiver of the IoTD 804 with respect to the discovery query 808. In another aspect, the wireless device 802 may transmit a discovery query 808 to the IoTD 804, and the wireless device 803 may receive the query response 814 from the IoTD 804 in a bistatic configuration, such as the bistatic configuration shown in FIG. 4A. In such a configuration, the wireless device 802 may be considered the RF source and the wireless device 803 may be considered the RF receiver of the IoTD 804 with respect to the discovery query 808. In another aspect, a plurality of wireless devices may be configured to communicate with a plurality of IoT devices using the process outlined in the communication flow diagram 800 between each pair of a wireless device (e.g., 802) and an IoTD (e.g., IoTD 804 or IoTD 805). The wireless device 802 or the wireless device 803 may be any device capable of transmitting a wireless signal, such as the RF source 610 in FIG. 6B, the UE 104 in FIG. 1, or the base station 102 in FIG. 1. The network node may be a base station, such as the base station 102 in FIG. 1, that serves the IoTD 804. The network node may configure the IoTD 804 using any suitable means, for example via an RRC configuration or via a MAC control element (MAC-CE).

In one aspect, the IoTD 804 may be preconfigured with a discovery configuration, for example in accordance with a standard, or may be loaded with a discovery configuration at a manufacturing facility. In one aspect, the wireless device 802 may transmit a discovery configuration 806 to the IoTD 804. The IoTD 804 may receive the discovery configuration 806 from the wireless device 802. In other words, the RF source of the IoTD 804 may configure how the IoTD 804 may respond to a discovery query. In another aspect, the network node 801 may transmit a discovery configuration 807 to the IoTD 804. The IoTD 804 may receive the discovery configuration 807 from the network node 801. In other words, a network serving the IoTD 804 may configure how the IoTD 804 may respond to a discovery query. In another aspect, the wireless device 803 may transmit the discovery configuration 811 to the IoTD 804. The IoTD 804 may receive the discovery configuration 811 from the wireless device 803. In other words, the RF receiver of the IoTD 804 may configure how the IoTD 804 may respond to a discovery query.

A discovery configuration (e.g., a pre-configuration, the discovery configuration 806, the discovery configuration 807, or the discovery configuration 811) may configure one or more resources for the IoTD 804 to use when responding to commands or queries from the wireless device 802. The discovery configuration 807 may be an RRC configuration. In one aspect, the discovery configuration may configure a command query occasion or a discovery request occasion similar to an SSB occasion. In other words, similar to how an SSB occasion may be mapped to a RACH occasion, a discovery request occasion may be mapped to a tag response occasion associated with an identifier of a tag or class of tags. One or more attributes of the discovery request occasion may be mapped to a tag response occasion based on one or more parameters of the tag response occasion. The attributes of the discovery request occasion may include, for example, a time allocation, a frequency allocation, a time configuration, a frequency configuration, a payload, a received power, a received reference signal received power (RSRP), a received reference signal received quality (RSRQ), a charging rate, or a received signal to interference plus noise ratio (SINR). The parameters of the tag response occasion may be, for example, a time offset from a discovery query time, a time allocation, a frequency allocation, a time configuration, a frequency configuration, a waveform ID, a coding ID, or a scrambling ID. The discovery configuration may allocate an ID for each occasion, and each occasion may have its own configuration. For example, an IoT device of a first class may be configured to respond to a discovery query having a charging rate over a first threshold, while an IoT device of a second class may be configured to respond to a discovery query having a charging rate over a second threshold.

The discovery query 808 may include an occasion ID, which may be used by the IoTD 804 to select a configuration of the discovery configuration. The discovery configuration may configure one or more frequency bands to send power/energy to the IoTD 804, one or more frequency bands to send data to the IoTD 804, or one or more frequency bands to send a CW signal containing data that may also be used to send power/energy to the IoTD 804. The discovery configuration may include an indicator of a first-time IoT device ID, which may be used by a new IoT device that has not yet been configured by the wireless device 802. For example, if the IoTD 804 receives a discovery request from the wireless device 802, but its memory does not have a record (e.g., an established ID associated with the wireless device 802) of being configured by the wireless device 802 (or its record is greater or equal than an expiration time threshold), then the IoTD 804 may transmit the configured first-time IoT device ID, otherwise the IoTD 804 may transmit a preconfigured ID. The discovery configuration may include an indicator of a set of unallocated IoT device IDs, which the IoTD 804 may use to select an ID if it determines that it is a new IoT device relative to the wireless device 802. A new IoT device with respect to the wireless device 802 may also be referred to as an unknown IoT device with respect to the wireless device 802.

The discovery configuration may indicate a format of a response to a discovery query, a response time, or a response resource. A format of a response to a discovery query may include, for example, what information the IoTD 804 may include in the query response 814 in response to the discovery query 808. A response time may include, for example, a time period when the IoTD 804 may transmit the query response 814 in response to the discovery query 808 (e.g., six slots after the discovery query, or two symbols after the discovery query). In some aspects, the discovery configuration may indicate a plurality of response times, such as a first response time for IoT devices having an established ID with the wireless device 802 and a second response time for IoT devices that do not have an established ID with the wireless device 802. The response time may include a time offset or a timer value. A response resource may include, for example, a set of frequencies that the IoTD 804 may use to transmit the query response 814 in response to the discovery query 808. In some aspects, the discovery configuration may indicate a plurality of resources, such as a first frequency band for IoT devices having an established ID with the wireless device 802 and a second frequency band for IoT devices that do not have an established ID with the wireless device 802. The discovery configuration may indicate an expiration condition that may cause an established IoTD to have an expired status, for example a time since the IoTD 804 has received a command or query from the wireless device 802.

The wireless device 802 may output a discovery query 808 to the IoTD 804. The discovery query 808 may be a command for the IoTD 804 to respond to. The IoTD 804 may receive the discovery query 808. The discovery query 808 may include a discovery configuration. The wireless device 802 may transmit the discovery query 808 as a broadcast, multicast, or unicast transmission. In one aspect, the wireless device 802 may transmit the discovery query 808 as a broadcast transmission to any IoT device that may receive the discovery query 808. In another aspect, the wireless device 802 may multicast the discovery query 808 as a multicast transmission to be responded to by any IoT device that satisfies a condition of the discovery query 808. In other words, the wireless device 802 may output the discovery query 808 to a defined set of IoT devices, or a set of IoT devices.

The group of IoT devices may be based on at least one of (a) an IoT device class, (b) a measurement type, (c) a data priority, (d) a type of information carried by the set of IoT devices, (e) a presence of data, (f) an amount of the data, (g) a distance from a radio frequency (RF) source device, or (h) a set of identifiers for the one or more IoT devices in the group. The discovery query 808 may have one or more identifiers that identify at least one of the aforementioned attributes, such that IoT devices that are associated with the one or more identifiers respond to the discovery query 808. In one aspect, the discovery query 808 may include an indicator of an IoT device class, and IoT devices may be configured to respond to discovery queries containing an indicator of an IoT device class associated with the IoT device. For example, the discovery query 808 may include a class of an IoT device and one or more types of measurements that may be performed by an IoT device, such as a first class that performs medical measurements (e.g., heartbeat, blood pressure), a second class that tracks assets, a third class that tracks animals, a fourth class that tracks humans, a fifth class that tracks objects (e.g., passports, phones, smartwatches), a sixth class that measures weather metrics (e.g., temperature, humidity), or a seventh class that measures a position. For example, the discovery query 808 may request measured weather metric data from one or more IoT devices having a class that measures weather metrics.

An IoT device or tag may be associated with a class. Each class may be associated with a type of measurement or a type of data. In one aspect, the discovery query 808 may include an indicator of a type of measurement that the IoT device is able to measure. In one aspect, the discovery query 808 may include a query requesting data for a sensed quantity or a measured quantity. In response to receiving a discovery query 808 that requests data for a sensed quantity or a measured quantity, the IoTD 804 may output a query response 814 including any quantity sensed or measured by the IoTD 804, or may output a query response 814 including a quantity associated with an identifier of the discovery query 808. In another aspect, the discovery query 808 may include a query requesting data for a sensed or measured quantity of a specific type (e.g., a weight or a temperature reading) from the IoTD 804, and, in response, the IoTD 804 may output a query response 814 including a sensed or measured quantity of the specific type. The types of measurements may include, for example, medical measurements (e.g., heartbeat, blood pressure), asset tracking measurements, animal tracking measurements, human tracking measurements, object tracking measurements (e.g., passports, phones, smartwatches), weather metric measurements (e.g., temperature, humidity), position measurements, expiration date measurements, or product measurements. IoT devices may be configured to respond to discovery queries containing an indicator of a measurement type associated with the IoT device. In one aspect, the discovery query 808 may include an indicator of a data priority that the IoT device may be associated with (e.g., the data saved on a memory of the IoT device may have a priority level), and IoT devices may be configured to respond to discovery queries containing an indicator of a priority associated with the IoT device. In some aspects, a data priority may be associated with a type of measurement or a type of data. For example, an IoT device may designate the priority of a medical measurement of a human to have a higher priority than a priority of an asset expiry date measurement or a medical measurement of an animal. In another example, an IoT device may designate a heartbeat measurement to have a higher priority value than a priority value of a pressure measurement. In such aspects, the IoT device may be configured to output data of a higher priority before outputting data of a lower priority, or may be configured to output data of a priority that is greater than or equal to a threshold value, and may not output data of a priority that is greater than or equal to the threshold value.

In some aspects, a data priority may be associated with a value of a data element. For example, a health condition of an entity (e.g., a person, or an animal) may have a first priority when a health value is below or equal to a threshold value, and may have a second priority when the health value is above or equal to the threshold value. Such a health value may be calculated based on a type of disease, patient history metrics, or family history metrics. The health value may be calculated based on a measurement collected by the IoT device.

In one aspect, the discovery query 808 may include an indicator of a type of information carried by the IoT device, and IoT devices may be configured to respond to discovery queries containing an indicator of a type of information that may be stored on the IoT device, or that the IoT device is capable of transmitting. In one aspect, the discovery query 808 may include an indicator of a presence of data on the IoT device, and IoT devices may be configured to respond to discovery queries containing an indicator of a presence of data if the IoT device has data saved on its memory. In one aspect, the discovery query 808 may include an indicator of an amount of data, or a data threshold, and IoT devices may be configured to respond to discovery queries containing an indicator of an amount of data if the IoT device has data saved on its memory that is greater or equal to the amount of data indicated by the discovery query 808. In one aspect, the discovery query 808 may include an indicator of a distance from an RF source device, and IoT devices may be configured to respond to discovery queries containing an indicator of a distance from an RF source device if the IoT device determines that it is within the distance from the RF source device. The RF source device may be the wireless device 802, or another RF source device that has transmitted data to the IoTD 804 in the past. For example, the IoTD 804 may have received a transmission from an RF source device other than the wireless device 802 that contains an indication of a location, and the IoTD 804 may use the indication of the location to determine the distance that the RF source device is from the IoTD 804. The discovery query 808 may contain an indication for IoT devices within a threshold distance from the RF source device to respond to the discovery query, and the IoTD 804 may respond if it determines that it is within a threshold distance from the RF source device. The distance may be measured in any suitable manner, for example by comparing an indication of a location of the RF source device (e.g., a GNSS fix response, a zone ID) with an indication of a location of the IoTD 804, by measuring an RSRP of a beam from the RF source device, by measuring a charging rate, estimating a pathloss, or by measuring a received power of a discovery query, such as the discovery query 808. In one aspect, the discovery query 808 may include an indicator of a set of IDs for one or more IoT devices, and IoT devices may be configured to respond to discovery queries containing an indicator of a set of IDs if the IoT device is associated with an ID of the set of IDs.

The discovery query 808 may be transmitted in a beamformed signal from the wireless device 802 and may carry beam information. The discovery query 808 may be transmitted per RFID class or for a set of RFID classes. The discovery query 808 may be transmitted for a group of IoT devices with different classes. For example, the discovery query 808 may group IoT devices based on a type of measurement, or based on a priority of data that the IoT devices have, or based on a type of information that the IoT devices carry. The discovery query 808 may be transmitted for IoT devices with data in their memory, or with data in their memory greater than a threshold size provided in the discovery query 808. The discovery query 808 may be transmitted based on a distance of the IoT device (e.g., within a number of meters from the wireless device 802) or a zone ID associated with the IoT device. A distance between the IoTD 804 and the wireless device 802 may be determined based on at least one of a charging rate, a reference signal received power (RSRP), a reference signal received quality (RSRQ), a received signal strength indicator (RSSI), a signal-to-noise ratio (SNR), a signal to interference plus noise ratio (SINR), a pathloss, or a power. For example, the discovery query 808 may indicate that the discovery query 808 targets IoT devices that measured a charging rate, an RSRP, a pathloss, or a power associated with the received signal of the discovery query 808 greater or equal to a threshold value. The discovery query 808 may be transmitted for a UID of the IoT devices (e.g., the discovery query 808 may include a set of hardware IDs). For example, each group of hardware IDs may be mapped or hashed to a common group of IoT devices, and the wireless device 802 may adjust the hashing key or mapping function to vary the scope of the discovery query 808. The discovery query 808 may include one or more IoT device IDs, such as IoT device IDs already known to the wireless device 802 as IoT devices previously discovered in a previous discovery query. In some aspects, the wireless device 802 may transmit the discovery query 808 based on a power level associated with a class meet a required charging rate of the class of IoT device or a distance of the IoT device. For example, the discovery query 808 may include two transmissions, a first transmission for a first IoT device class associated with a first power level to charge the first IoT device class, and a second transmission for a second IoT device class associated with a second power level to charge the second IoT device class. In this aspect, the reading process at 816 may be distance-based. In other words, different power levels may be used to read from each set of IoT devices (e.g., a first power level to read a first set of IoT devices and a second power level to read a second set of IoT devices).

The IoTD 804 may be configured to respond to the discovery query 808 based on at least one measured metric of the discovery query 808, for example a received power, an RSRP, an RSRQ, an SNR, or an SINR. The IoTD 804 may be preconfigured with such behavior, for example configured according to a specification or pre-loaded with such behavior, or the IoTD 804 may be configured with such behavior, for example based on a configuration signal received by the IoTD 804. In some aspects, the IoTD 804 may be configured to respond to the discovery query 808 based on at least one measured metric of the discovery query 808 by an indication in the discovery configuration 806 or the discovery query 808. The IoTD 804 may compare the one or more measured metrics against one or more threshold values (e.g., greater than, greater than or equal to, less than, less than or equal to) to influence one or more responses. For example, in response to the RSRP of the discovery query 808 being greater or equal to a threshold value, the IoTD 804 may transmit a query response 814 to the discovery query 808. In another aspect, in response to the RSRP of the discovery query 808 being greater or equal to a first threshold value, and in response to the SINR of the discovery query 808 being greater or equal to a second threshold value, the IoTD 804 may be configured to use a first response time to transmit the query response 814. The IoTD 804 may be configured or preconfigured to determine whether or not to transmit the query response 814, determine a response time for the query response 814, determine what resources to use for the query response 814, or determine a scrambling ID to use with the query response 814 based on the comparison of the one or more measured metrics against the one or more threshold values. Even if the input received power exceeds the threshold for powering the IC of the IoTD 804, the IoTD 804 may not respond to the discovery query 808 if a measured metric does not satisfy a comparison.

At 810, the IoTD 804 may measure one or more beams of the discovery query 808. For example, the IoTD 804 may measure a charging rate, an RSRP, a pathloss, or a power associated with the discovery query 808. In some aspects, at 810, the IoTD 804 may measure the timing of beams received by the IoTD 804. The IoTD 804 may perform RRM on beams received by the IoTD 804. The IoTD 804 may perform channel measurements on beams received by the IoTD 804. The IoTD 804 may use one or more of the measurements to determine the best beam information for the next read from the wireless device 802. The IoTD 804 may periodically measure beams at 810 so that the IoTD 804 may measure beam changes or RRM. In some aspects, the IoTD 804 may have a battery to assist in its periodic measurements and recordation of measurements. In some aspects, the wireless device 802 may command the IoTD 804 to report RRM, its best observed beam, or best set of associated IDs (e.g., RF source ID, cell ID, beam ID, RF reader ID) via the backscatter communication 818. The set of associated IDs may include, for example RF source ID and beam ID pairs, RF reader ID and beam ID pairs, or sets of RF source ID, beam ID, and RF reader ID. For example, the wireless device 802 may command the IoTD 804 to periodically report RRM, best observed beam, or best set of associated IDs via the backscatter communication 818. In another aspect, the wireless device 802 may command the IoTD 804 to report RRM, best observed beam, or best set of associated IDs dynamically. The IoTD 804 may transmit the response as a report via the backscatter communication 818. The IoTD 804 may transmit the report on a backscattered signal reflected by the IoTD 804. The IoTD 804 may have one or more active components that generate one or more signals/waveforms that include the report on one or more resources dedicated to the IoTD 804. The resources may be dedicated to the IoTD 804 via the discovery configuration 806. In some aspects, the IoTD 804 may not measure any beams at 810 as the IoTD 804 may have received a best beam from the discovery query. In one aspect, the discovery configuration 806 from the wireless device 802 may include a best beam of the wireless device 802. The wireless device 802 may determine its best beam based upon feedback from other devices, such as the IoTD 805, the wireless device 803, or the network node 801. In another aspect, the discovery configuration 807 from the network node 801 may include a best beam of the wireless device 802. The network node 801 may determine a best beam of the wireless device 802 based on which RACH occasion from the wireless device 802 the network node 801 used with respect to an SSB.

The IoTD 804 may determine whether to respond to the discovery query 808 based on one or more one or more of (a) the IoT device class, (b) a measurement of a signal carrying the group discovery query, (c) the data priority for transmission by the IoT device, (d) a quality of service of the data for the transmission by the IoT device, (e) the amount of the data for the transmission by the IoT device, (f) the IoT device not having an established ID with the RF source device, (g) a UID (e.g., a hardware ID) for the IoT device, (h) a password associated with the IoT device, (i) a Zone ID, (j) a configuration parameter of the group discovery query, (k) a beam ID, (l) an RF source ID, (m) an RF reader ID, or (o) a cell ID. Responding to the discovery query 808 may include executing a command of the discovery query 808. In one aspect, the IoTD 804 may respond to the discovery query 808 based on the IoT device class associated with the IoTD 804 being indicated in the discovery query 808. In one aspect, the IoTD 804 may respond to the discovery query 808 based on a measurement of the signal carrying the discovery query 808 being greater or equal to a threshold value. The threshold value may be the minimum strength of a signal required to activate the IoTD 804. In one aspect, the IoTD 804 may respond to the discovery query 808 based on a measurement of the signal carrying the discovery query 808 being in between two threshold values, as a signal greater than a higher threshold value may correspond with a different group of IoT devices. In one aspect, the IoTD 804 may respond to the discovery query 808 based on the data priority for transmission by the IoTD 804 being associated with a data priority associated with the IoTD 804. For example, the IoTD 804 may have data saved in its memory having a priority that is associated with a data priority indicated in the discovery query 808 or the discovery configuration 806. In one aspect, the IoTD 804 may respond to the discovery query 808 based on a quality of service of the data for the transmission by the IoTD 804. For example, data saved on a memory of the IoTD 804 may be associated with a quality of service that is indicated in the discovery query 808. In one aspect, the IoTD 804 may respond to the discovery query 808 based on the amount of the data for the transmission by the IoTD 804. For example, data saved in a portion of the IoTD 804 may meet or exceed a data threshold indicated in the discovery query 808. In one aspect, the IoTD 804 may respond to the discovery query 808 based on the IoTD 804 not having an established ID with the wireless device 802. For example, the IoTD 804 may respond to the discovery query 808 if it determines that the IoT device does not have an established ID with respect to the wireless device 802.

In one aspect, the discovery query 808 may have an ID of the wireless device 802, and the IoTD 804 may save a set of IDs for wireless devices that have an established ID with the IoTD 804. Each of the set of IDs may be associated with a timestamp, for example a timestamp of when the established ID was provided to the IoTD 804, which may be used to determine if an established ID has expired or not (e.g., if the IoTD 804 would consider itself a new device with respect to the wireless device 802). The IoTD 804 may determine that an established ID has expired based on an indication of expiration, such as at least one of (a) a timer expiration, (b) passage of a duration of time, (c) completion of a read connection, or (d) an indication in write or read session from the wireless device 802 or an RF reader (e.g., the RF reader 414 in FIG. 4A) indicating a connection expiration. In one aspect, the IoTD 804 may respond to the discovery query 808 based on a UID for the IoTD 804. For example, the discovery query 808 may have an indicator of a UID that matches a UID for the IoTD 804, which may trigger the IoTD 804 to respond to the discovery query 808. In one aspect, the IoTD 804 may respond to the discovery query 808 based on a password associated with the IoTD 804. For example, the IoTD 804 may have an access password, and may respond to a discovery query 808 that use the access password. In some aspects, the IoTD 804 may have a kill password, which, if received, may inactivate the IoTD 804 for a period of time or may indicate an end of communication with the wireless device 802. The kill password, or the access password, or both the access and the kill password may be used as an input to a function or hashing function of the IoTD 804. The output of the function or the hashing function may select a discovery configuration, or a portion of a discovery configuration, such as timing information, resources for transmitting the query response 814, a scrambling ID to use at 812 to scramble the query response 814, or a configuration for the IoTD 804 to monitor.

In one aspect, the IoTD 804 may respond to the discovery query 808 based on a zone ID associated with the IoTD 804 matching a zone ID indicated in the discovery query 808. In one aspect, the IoTD 804 may respond to the discovery query 808 based on a configuration parameter of the group discovery query. For example, the IoTD 804 may use a multiple-access protocol (e.g., Q protocol, ALOHA protocol, singulation protocol or other protocols), which may have parameters associated per class or across all classes or a subset of classes. For example, the Q protocol may have a Q value which may be provided in the discovery query 808 and may be parameterized per class, per data priority, per data quality of service, per IoT device class, per received power, per whether the IoT device has an established ID with respect to the wireless device 802, per IoT device ID, per zone ID associated with the IoTD 804 per RF source ID, per RF reader ID, per cell ID, or per beam ID. In one aspects, the beam ID may be used for two tags that may have the same pair of RF sources and RF readers. In one aspect, the IoTD 804 may respond to the discovery query 808 based on a beam ID associated with the IoTD 804 being indicated by the discovery query 808. In one aspect, the IoTD 804 may respond to the discovery query 808 based on an RF source ID indicated by the discovery query 808. For example, the IoTD 804 may be configured to respond to a discovery query 808 from any of a set of wireless devices identified by an RF source ID. In one aspect, the IoTD 804 may respond to the discovery query 808 based on RF reader ID. For example, the discovery query 808 may indicate an RF reader ID associated with a wireless device to receive the query response 814, and the IoTD 804 may transmit the query response 814 in response to the RF reader ID in the discovery query 808 matching with an RF reader ID saved in the memory of the IoTD 804.

At 812 the IoTD 804 may scramble the query response 814 to the wireless device 802. The IoTD 804 may scramble the query response 814 using an RFID device ID associated with the IoTD 804. The RFID device ID may be, for example, a first-time IoT device ID or an IoT device ID assigned to the IoTD 804 during a previous discovery procedure. The IoTD 804 may scramble the query response 814 using an ID from a set for IoT devices without the established ID with the wireless device 802.

In one aspect, the IoTD 804 may determine that it is a new IoT device relative to the wireless device 802. For example, the IoTD 804 may search its memory and determine that a wireless device ID sent in the discovery query 808 is not in a list of wireless devices that the IoTD 804 has previously communicated with, or may determine that the wireless device 802 has not communicated with the IoTD 804 within a threshold period of time. The IoTD 804 may transmit a query response 814 including an invalid ID (e.g., a null value or a zero value), or with a first-time IoT device ID. In some aspects, the IoT device may select a random value from a set of unallocated IoT device IDs, and may scramble the query response 814 with the selected ID at 812. The wireless device 802 may transmit the set of unallocated IoT device IDs in the discovery query 808 or the discovery configuration 806. In a following discovery cycle, the wireless device 802 may not transmit the IoT device ID selected by the IoTD 804. In some aspects, the IoTD 804 may select a second ID, and may scramble the second ID with its selected IoT device ID at 812. In some aspects, the IoT device may be configured to select a time to transmit the query response 814 from a set of times to respond to the discovery query 808. The set of times to respond to the discovery query 808 may be transmitted in the discovery configuration 806 or in the discovery query 808.

In one aspect, the IoTD 804 may determine that it is an old or known IoT device relative to the wireless device 802. For example, the IoTD 804 may search its memory and determine that a wireless device ID sent in the discovery query 808 is in a list of wireless devices that the IoTD 804 has previously communicated with, or may determine that the wireless device 802 has communicated with the IoTD 804 within a threshold period of time. The IoTD 804 may transmit the IoT device ID assigned to it by the wireless device 802 in the past. An IoT device ID that has been assigned to the IoTD 804 by the wireless device 802 in the past may be referred to as an established ID. The IoTD 804 may scramble the query response 814 with the IoT device ID at 812. In another aspect, the IoTD 804 may scramble the query response 814 with a second ID selected based on one or more parameters of the IoTD 804.

The query response 814 may include at least one of a resource, a time, an offset, a scrambling sequence, an IoT device ID, beam information, an RF source ID, or an RF reader ID. The resource may be a resource used to transmit the query response 814. The resource associated with the IoTD 804 may be indicated by the discovery configuration 806 or by the discovery query 808. The time may be, for example, a time period allocated for the IoT device to transmit the query response 814. The time associated with the IoTD 804 may be indicated by the discovery configuration 806 or by the discovery query 808. The offset may be, for example, a time offset that the IoTD 804 uses to transmit the query response 814 after receipt of the discovery query 808. The offset associated with the IoTD 804 may be indicated by the discovery configuration 806 or by the discovery query 808. The scrambling sequence may be an ID used by the IoTD 804 to scramble the response at 812, such as an established ID of the IoTD 804, a first-time IoT device ID, a selected ID from a set of unallocated IoT device IDs, a UID of the IoTD 804, a hardware ID of the IoTD 804, a zone ID associated with the IoTD 804, a beam ID associated with the IoTD 804, an RF source ID associated with the IoTD 804, or an RF reader ID associated with the IoTD 804. Which IDs the IoTD 804 may use to scramble the response at 812 may be indicated by the discovery configuration 806 or by the discovery query 808. For example, the discovery query 808 may include a command to scramble the response using a selected ID from the set of unallocated IoT device IDs and the RF source ID of the wireless device 802, which may be included in the discovery query 808. The IoT device ID may be an ID associated with the IoTD 804, such as an established ID associated with the wireless device 802 and the IoTD 804, a first-time IoT device ID, or a selected ID from a set of unallocated IoT device IDs. The beam information may include resource information about the transmissions from the IoTD 804. The RF source ID may include an ID associated with the wireless device 802, or may include a set of IDs associated with wireless devices that have communicated with the IoTD 804. The RF reader ID may include an ID associated with a wireless device that have been designated to receive a transmission from the IoTD 804, such as a target device indicated in the discovery query 808 or the discovery configuration 806.

In one aspect the IoTD 804 may be configured to transmit the query response 814 using a resource or a timer offset based on a parameter of the IoTD 804. By transmitting the query response 814 using a resource or a timer offset, the IoTD 804 may reduce a chance of a collision when transmitting a response during the same response occasion as another IoTD, such as the IoTD 805 that transmits the query response 813. The resource or the timer offset may be selected based on any suitable parameter, such whether the IoTD 804 is a new IoTD, an established IoTD, or an expired IoTD with respect to the wireless device 802, an IoT device class of the IoTD, a beam ID, an RF source ID, the IoT device ID, an RF reader ID, or a cell ID. For example, if the IoTD 804 is a new IoT device with respect to the wireless device 802 and the IoTD 805 is an established IoT device with respect to the wireless device 802, the IoTD 804 may transmit the query response 814 using a first timer offset T1 and the IoTD 805 may transmit the query response 813 using a second timer offset T2, and/or the IoTD 804 may transmit the query response 814 using a first resource R1 and the IoTD 805 may transmit the query response 813 using a second resource R2. The resource or the offset may be provided in a command, such as the discovery query 808, or in the discovery configuration 806. For example, resources and/or time offsets for a new IoT device may be preconfigured using the discovery configuration 806 or configured using the discovery query 808. In some aspects, the discovery query 808 may provide a current time that the IoTD 804 may use to determine if it is an expired device relative to the wireless device 802. In other aspects, the IoTD 804 may have a capability to maintain its own timing, for example by using a crystal clock or a solid state clock that may have its own energy storage unit, or battery, separate from the power source that the IC of the IoTD 804 uses.

Such a clock may be powered by any suitable means, for example by harvesting RF energy or by harvesting solar energy to maintain the clock. The clock may be synchronized by periodic signals from the wireless device 802, the network node 801, or the wireless device 803. The ability of the IoTD 804 to maintain its own timing may be indicated via communication with at least one of a NW node or an RF reader node or an RF source node or via a class of the IoTD 804. In one aspect, the discovery query 808 may include a timing maintenance capability command or query, and the query response 814 may include a capability of the IoTD 804 to maintain its own timing. In another aspect, the backscatter communication 818 may include a capability command or query to the IoTD 804, and the IoTD 804 may transmit an indicator of its capability in the query response 814 to the wireless device 802. In some aspects, if IoTD 804 may be configured to be active or to generate its own waveforms, the IoTD 804 may indicate its capability to the network (e.g, to the network node 801) during its initial access as a response to a capability inquiry in a query or a command. The query or the command could be, for example, from the network node 801, the wireless device 802, the wireless device 803, or from an RF reader. In some aspects, the query or the command may be indicated over time using L1/L2/L3 signaling from the IoTD 804 to the network (e.g., via the network node 801), the wireless device 802, an RF reader, another wireless device 803, or a combination thereof. The indication of capability may be a binary value that indicates whether or not the IoTD 804 has the capability to maintain its own timing. In some aspects, the indication of capability may also indicate whether or not the maintenance of the IoTD 804's timing uses the network to maintain its timing (e.g., by synchronizing its clock using a clock signal from the network node 801. In some aspects, the indication of capability may be included as a part of the class of the IoTD 804. For example, a class may indicate a capability of the IoTD 804 to maintain its own timing.

In some aspects, the network node 801 may transmit a periodic clock signal or a requested reference clock signal to help the IoTD 804 adjust for clock drift, timing errors, and/or frequency errors. Such periodic signals may alternatively or also be used by the IoTD 804 to power its IC by harvesting power from the RF waves. Such periodic signals may be transmitted by any wireless device, such as the network node 801, the wireless device 802, or the wireless device 803. In some aspects, the IoTD 804 may be configured to transmit a request for one or more signals to be transmitted in response to its power being less than or equal to a threshold value. In some aspects, the wireless device 802 or the network node 801 may be configured to periodically transmit an RF signal to provide power to the IoTD 804, and/or a clock signal to help the IoTD 804 synchronize its clock with the transmitting device.

In one aspect, the IoTD 804 may be configured to transmit the query response 814 using at least one of a resource, a timer offset, or a scrambling ID based on a parameter of the IoTD 804. For example, the at least one of the resource, the timer offset, or the scrambling ID may be selected based on at least one of (a) an IoT device class of the IoTD 804, (b) an RSRP measured by the IoTD 804, (c) an RSRQ measured by the IoTD 804, (d) an RSSI measured by the IoTD 804, (e) a priority of data (e.g., level 1 or higher) saved on a memory of the IoTD 804, (f) a quality of service (QOS) of data (e.g., level 1 or higher) saved on a memory of the IoTD 804 (g) an amount of data saved on a memory of the IoTD 804, (h) whether the IoTD 804 is new, established, or expired relative to the wireless device 802, (i) an ID of the IoTD 804 (e.g., an established ID, a new ID, an unallocated ID), (j) a UID associated with the IoTD 804, (k) a hardware ID associated with the IoTD 804, (l) a tag access password associated with the IoTD 804, (m) a tag kill password associated with the IoTD 804, (n) a zone ID associated with the IoTD 804, (o) a command configuration received by the IoTD 804, (p) a beam ID associated with the IoTD 804, (q) an RF source ID, or (r) an RF reader ID. In some aspects, there may be an RSRP/RSRQ/RSSI threshold range that may be associated with at least one of a resource, a time offset, or a scrambling ID. In some aspects, a parameter may be associated with a set of resources, time offsets, or scrambling IDs which may be selected based on a randomizer by the IoTD 804 to further encourage non-collision of transmissions with the query response 814. In some aspects, if a memory of the IoTD 804 is empty, the IoTD 804 may not respond to the discovery query 808 unless the discovery query 808 is associated with performing an RRM or a CSI measurement.

The IoTD 804 may select a resource to transmit the query response 814 based on at least one of a beam ID, an RF source ID, the IoT device ID, an RF reader ID, or a cell ID. In one aspect, the discovery query 808 or the discovery configuration 806 may identify a resource based on at least one of a beam ID, the RF source ID, the IoT device ID, an RF reader ID, or a cell ID. The wireless device 802 may also transmit one or more requests 815 for information from the IoTD 804, for example a request for a class of the IoTD 804 or a query for a UID of the IoTD 804. Such information may be used by the wireless device 802 to configure the IoTD 804.

The discovery query 808 may also be received by other IoTD devices, such as the IoTD 805. Similar to the IoTD 804, the IoTD 805 may respond to the discovery query 808 as a query response 813.

At 816, the wireless device 802 may process the query response 814. In one aspect, if the query response includes an established ID associated with the wireless device 802 and the IoTD 804, the wireless device 802 may transmit an acknowledgement as the backscatter communication 818. The IoTD 804 may then update a timestamp associated with the established ID in response to one or more received communications from the wireless device via backscatter communication 818. For example, the IoTD 804 may update the timestamp after every five transmissions received from the wireless device 802. In one aspect, if the query response indicates that the IoTD 804 does not have an established ID associated with the wireless device 802 and the IoTD 804, the wireless device 802 may transmit an indication to use a new ID or to continue using a prior ID (e.g., a selected unused ID) used in the query response 814 to the discovery query 808 as an assignment 817 of an ID to the IoTD 804. The IoTD 804 may then communicate with the IoTD 804 via backscatter communication 818 based on the IoT device ID associated with the wireless device 802 and the IoTD 804. The assignment 817 may also include configuration data for the IoTD 804, for example a resource, a timing offset, or a scrambling ID for the IoTD 804 to use for the backscatter communication 818. In some aspects, the resources may be indicated by the assignment 817 or the discovery configuration 806. In some aspects, the resources may be indicated by a UID associated with the IoTD 804. In some aspects, the resources may be mapped one-to-one to resources selected for transmitting the assignment 817. For example, the IoTD 804 may use a resource to perform the backscatter communication 818 based on the resource used to transmit the assignment 817. In some aspects, the resources may be mapped one-to-many to resources selected for transmitting the assignment 817, and the IoTD 804 may select a resource from the plurality of possible resources based on a parameter associated with the IoTD 804, or based on a randomizer.

In some aspects, the wireless device 802 may transmit the discovery query 808 with a beamformed signal, where the signal may carry the beamforming information. The beamformed signal may be based on a sequence such as PSS, SSS, or demodulation reference signal (DMRS) of a PBCH. The beam ID of the beamformed signal may be modulated based on at least one of a PSS, SSS, or DMRS joint encoding method. The IoTD 804 may transmit the query response 814 with the beam information. The wireless device 802 may be configured to serve the IoTD 804 with the beam. In aspects where the IoTD 804 may communicate with a plurality of wireless devices, the query response 814 may include an RF source ID, a beam ID, and/or a UID associated with the IoTD 804.

The backscatter communication 818 between the wireless device 802 and the IoTD 804 may include, for example, (a) an indication to use a new ID or to continue using a prior ID used in the response to the group discovery query, (b) first timing information for an additional query, (c) resource information for the additional query, (d) a continuous wave configuration for the additional query, (e) second timing information for the IoT device, (f) a request for class information from the IoT device, (g) data from a radio frequency source, (h) the additional query for the IoT device, or (i) a command for the IoT device. In one aspect, the wireless device 802 may schedule a future transmission with the IoTD 804, for example by transmitting timing information for the future transmission, resource information for the future transmission, or a continuous wave configuration for the future transmission. The future transmission may be a command or a query. In response the IoTD 804 may communicate with the wireless device 802 in accordance with the schedule. The wireless device 802 may transmit a request for class information from the IoTD 804 as the backscatter communication 818, and in response the IoTD 804 may provide the requested class information as the backscatter communication 818. The wireless device 802 may transmit data as an RF signal to the IoTD 804 as the backscatter communication 818.

The backscatter communication 818 may include at least one of (a) indicated data resources corresponding to an RFID device, (b) a resource mapped to the resource for sending an identifier for the IoT device, (c) the IoT device class, (d) a measurement of a signal carrying the group discovery query, (e) the data priority for transmission by the IoT device, (f) a quality of service of the data for the transmission by the IoT device, (g) the amount of the data for the transmission by the IoT device, (h) the IoT device not having an established ID with the RF source device, (i) a hardware ID for the IoT device, (j) a password associated with the IoT device, (k) a Zone ID, (l) a configuration parameter of the group discovery query, (m) a beam ID, (n) an RF source ID, (o) an RF reader ID, or (p) a cell ID.

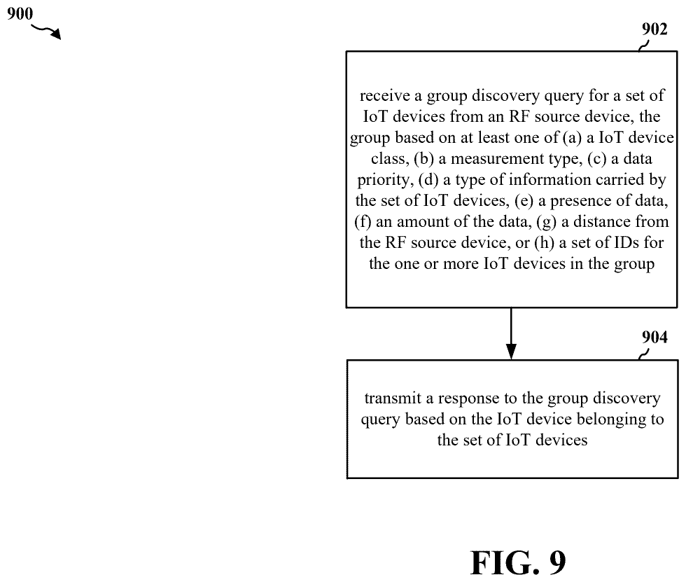

FIG. 9 is a flowchart 900 of a method of wireless communication. The method may be performed by an IoT device (e.g., the IoT device 106, the IoT device 310, the IoTD 416, the IoTD 620, the IoTD 804). At 902, the IoT device may receive a group discovery query for a set of IoT devices from an RF source device, the group based on at least one of (a) a IoT device class, (b) a measurement type, (c) a data priority, (d) a type of information carried by the set of IoT devices, (e) a presence of data, (f) an amount of the data, (g) a distance from the RF source device, or (h) a set of IDs for the one or more IoT devices in the group. For example, 902 may be performed by the IoTD 804 in FIG. 8, which may receive a discovery query 808 for a set of IoT devices from the wireless device 802. The one or more IoT devices may include the IoTD 804. The group may be based on at least one of (a) an IoT device class, (b) a measurement type, (c) a data priority, (d) a type of information carried by the set of IoT devices, (e) a presence of data, (f) an amount of the data, (g) a distance from the wireless device 802, or (h) a set of identifiers for the one or more IoT devices in the group. Moreover, 902 may be performed by the component 197 in FIG. 5.

At 904, the IoT device may transmit a response to the group discovery query based on the IoT device belonging to the set of IoT devices. For example, 904 may be performed by the IoTD 804 in FIG. 8, which may transmit a query response 814 to the discovery query 808 based on the IoTD 804 belonging to the group of the one or more IoT devices. Moreover, 904 may be performed by the component 197 in FIG. 5.

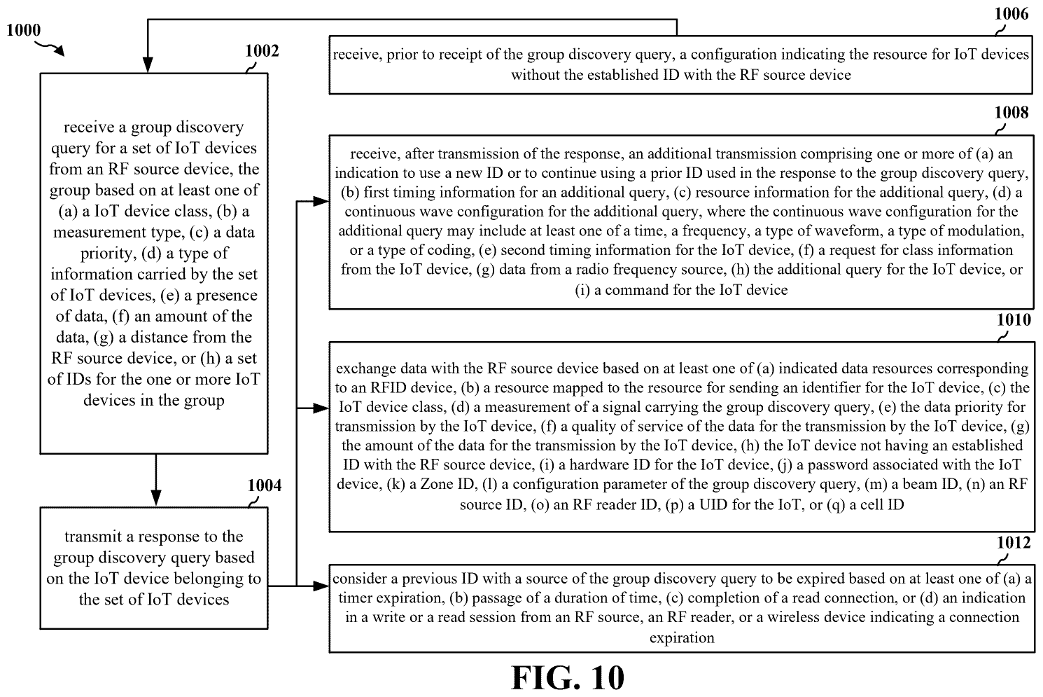

FIG. 10 is a flowchart 1000 of a method of wireless communication. The method may be performed by an IoT device (e.g., the IoT device 106, the IoT device 310, the IoTD 416, the IoTD 620, the IoTD 804). At 1002, the IoT device may receive a group discovery query for a set of IoT devices from an RF source device, the group based on at least one of (a) a IoT device class, (b) a measurement type, (c) a data priority, (d) a type of information carried by the set of IoT devices, (e) a presence of data, (f) an amount of the data, (g) a distance from the RF source device, or (h) a set of IDs for the one or more IoT devices in the group. For example, 1002 may be performed by the IoTD 804 in FIG. 8, which may receive a discovery query 808 for a set of IoT devices from the wireless device 802. The one or more IoT devices may include the IoTD 804. The group may be based on at least one of (a) an IoT device class, (b) a measurement type, (c) a data priority, (d) a type of information carried by the set of IoT devices, (e) a presence of data, (f) an amount of the data, (g) a distance from the wireless device 802, or (h) a set of identifiers for the one or more IoT devices in the group. Moreover, 1002 may be performed by the component 197 in FIG. 5.

At 1004, the IoT device may transmit a response to the group discovery query based on the IoT device belonging to the set of IoT devices. For example, 1004 may be performed by the IoTD 804 in FIG. 8, which may transmit a query response 814 to the discovery query 808 based on the IoTD 804 belonging to the group of the one or more IoT devices. Moreover, 1004 may be performed by the component 197 in FIG. 5.

At 1006, the IoT device may receive, prior to receipt of the group discovery query, a configuration indicating the resource for IoT devices without the established ID with the RF source device. For example, 1006 may be performed by the IoTD 804 in FIG. 8, which may receive a discovery configuration 806 prior to receiving the discovery query 808. The discovery configuration 806 may indicate a set of resources for the IoTD 804 without an established ID with the wireless device 802 to use, such as the first-time IoT device ID. Moreover, 1006 may be performed by the component 197 in FIG. 5.

At 1008, the IoT device may receive, after transmission of the response, an additional transmission comprising one or more of (a) an indication to use a new ID or to continue using a prior ID used in the response to the group discovery query, (b) first timing information for an additional query, (c) resource information for the additional query, (d) a continuous wave configuration for the additional query, (e) second timing information for the IoT device, (f) a request for class information from the IoT device, (g) data from a radio frequency source, (h) the additional query for the IoT device, or (i) a command for the IoT device. The continuous wave configuration for the additional query may include at least one of a time, a frequency, a type of waveform, a type of modulation, or a type of coding. For example, 1008 may be performed by the IoTD 804 in FIG. 8, which may receive backscatter communication 818 after transmitting the query response 814. The backscatter communication 818 may include one or more of (a) an indication to use a new ID or to continue using a prior ID used in the response to the group discovery query, (b) first timing information for an additional query, (c) resource information for the additional query, (d) a continuous wave configuration for the additional query, (e) second timing information for the IoT device, (f) a request for class information from the IoT device, (g) data from a radio frequency source, (h) the additional query for the IoT device, or (i) a command for the IoT device. The continuous wave configuration for the additional query may include at least one of a time, a frequency, a type of waveform, a type of modulation, or a type of coding. Moreover, 1008 may be performed by the component 197 in FIG. 5.

At 1010, the IoT device may exchange data with the RF source device based on at least one of (a) indicated data resources corresponding to an RFID device, (b) a resource mapped to the resource for sending an identifier for the IoT device, (c) the IoT device class, (d) a measurement of a signal carrying the group discovery query, (e) the data priority for transmission by the IoT device, (f) a quality of service of the data for the transmission by the IoT device, (g) the amount of the data for the transmission by the IoT device, (h) the IoT device not having an established ID with the RF source device, (i) a UID for the IoT device, (j) a password associated with the IoT device, (k) a Zone ID, (l) a configuration parameter of the group discovery query, (m) a beam ID, (n) an RF source ID, (o) an RF reader ID, (p) a hardware ID for the IoT device, or (q) a cell ID. For example, 1010 may be performed by the IoTD 804 in FIG. 8, which may exchange data with the wireless device 802 as the backscatter communication 818. The IoTD 804 may communicate with the wireless device 802 based on at least one of (a) indicated data resources corresponding to an RFID device, (b) a resource mapped to the resource for sending an identifier for the IoT device, (c) the IoT device class, (d) a measurement of a signal carrying the group discovery query, (e) the data priority for transmission by the IoT device, (f) a quality of service of the data for the transmission by the IoT device, (g) the amount of the data for the transmission by the IoT device, (h) the IoT device not having an established ID with the RF source device, (i) a UID for the IoT device, (j) a password associated with the IoT device, (k) a Zone ID, (l) a configuration parameter of the group discovery query, (m) a beam ID, (n) an RF source ID, (o) an RF reader ID, (p) a hardware ID for the IoT device, or (q) a cell ID. Moreover, 1010 may be performed by the component 197 in FIG. 5.

At 1012, the IoT device may consider a previous ID with a source of the group discovery query to be expired based on at least one of (a) a timer expiration, (b) passage of a duration of time, (c) completion of a read connection, or (d) an indication in a write or a read session from an RF source, an RF reader, or a wireless device indicating a connection expiration. For example, 1012 may be performed by the IoTD 804 in FIG. 8, which may consider a previous ID, or an established ID, with the wireless device 802 to be expired based on at least one of (a) a timer expiration, (b) passage of a duration of time, (c) completion of a read connection, or (d) an indication in write or read session from an RF source, an RF reader, or a wireless device indicating a connection expiration. The wireless device may be a wireless device not shown in FIG. 8, such as a base station 102 or another UE 104 in FIG. 1. Moreover, 1012 may be performed by the component 197 in FIG. 5.

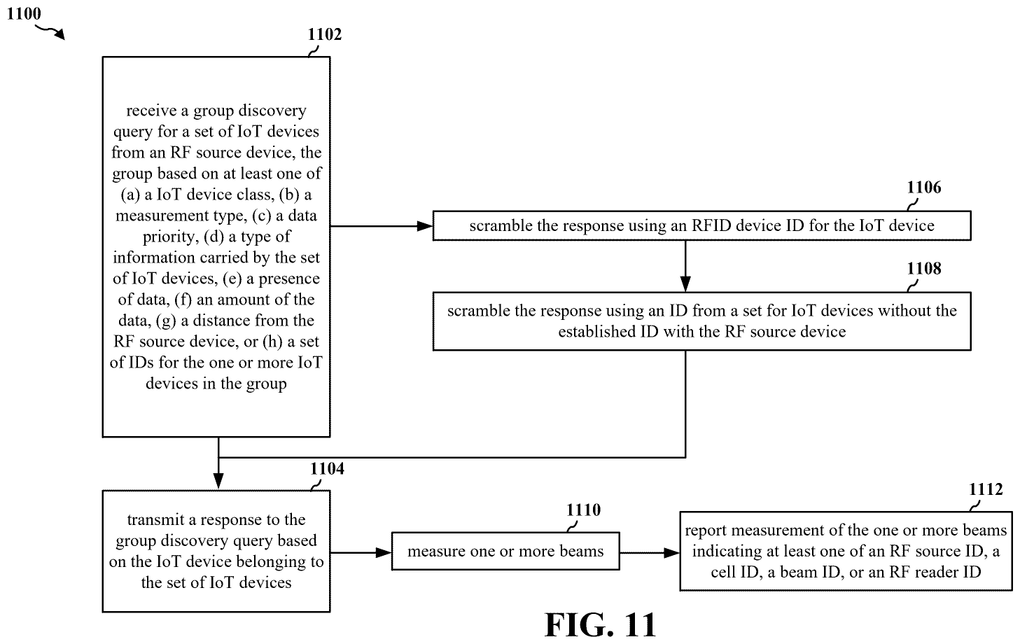

FIG. 11 is a flowchart 1100 of a method of wireless communication. The method may be performed by an IoT device (e.g., the IoT device 106, the IoT device 310, the IoTD 416, the IoTD 620, the IoTD 804). At 1102, the IoT device may receive a group discovery query for a set of IoT devices from an RF source device, the group based on at least one of (a) a IoT device class, (b) a measurement type, (c) a data priority, (d) a type of information carried by the set of IoT devices, (e) a presence of data, (f) an amount of the data, (g) a distance from the RF source device, or (h) a set of IDs for the one or more IoT devices in the group. For example, 1102 may be performed by the IoTD 804 in FIG. 8, which may receive a discovery query 808 for a set of IoT devices from the wireless device 802. The one or more IoT devices may include the IoTD 804. The group may be based on at least one of (a) an IoT device class, (b) a measurement type, (c) a data priority, (d) a type of information carried by the set of IoT devices, (e) a presence of data, (f) an amount of the data, (g) a distance from the wireless device 802, or (h) a set of identifiers for the one or more IoT devices in the group. Moreover, 1102 may be performed by the component 197 in FIG. 5.

At 1104, the IoT device may transmit a response to the group discovery query based on the IoT device belonging to the set of IoT devices. For example, 1104 may be performed by the IoTD 804 in FIG. 8, which may transmit a query response 814 to the discovery query 808 based on the IoTD 804 belonging to the group of the one or more IoT devices. Moreover, 1104 may be performed by the component 197 in FIG. 5.

At 1106, the IoT device may scramble the response using an RFID device ID for the IoT device. For example, 1106 may be performed by the IoTD 804 in FIG. 8, which may scramble the query response 814 at 812 using an RFID device ID for the IoTD 804, such as a first-time IoT device ID or a previously established ID. Moreover, 1106 may be performed by the component 197 in FIG. 5.

At 1108, the IoT device may scramble the response using an ID from a set for IoT devices without the established ID with the RF source device. For example, 1108 may be performed by the IoTD 804 in FIG. 8, which may scramble the query response 814 at 812 using an ID from a set for IoT devices without the established ID with the wireless device 802, such as a first-time IoT device ID or an ID from a set of unallocated IoT device IDs. Moreover, 1108 may be performed by the component 197 in FIG. 5.

At 1110, the IoT device may measure one or more beams. For example, 1110 may be performed by the IoTD 804 in FIG. 8, which may measure one or more beams of the discovery query 808. The wireless device 802 may periodically transmit discovery queries, such as the discovery query 808, and the IoTD 804 may measure one or more of the beams of the discovery queries. Moreover, 1110 may be performed by the component 197 in FIG. 5.

At 1112, the IoT device may report measurement of the one or more beams indicating at least one of an RF source ID, a cell ID, a beam ID, or an RF reader ID. For example, 1112 may be performed by the IoTD 804 in FIG. 8, which may report the measurement of the one or more beams as backscatter communication 818 with the wireless device 802. The report may indicate at least one of an RF source ID, a cell ID, a beam ID, or an RF reader ID. For example, the report may indicate a best beam ID, or may indicate a set of IDs related to one another, such as a best RF source ID and beam ID pair, or a best RF reader ID and beam ID pair. Moreover, 1112 may be performed by the component 197 in FIG. 5.

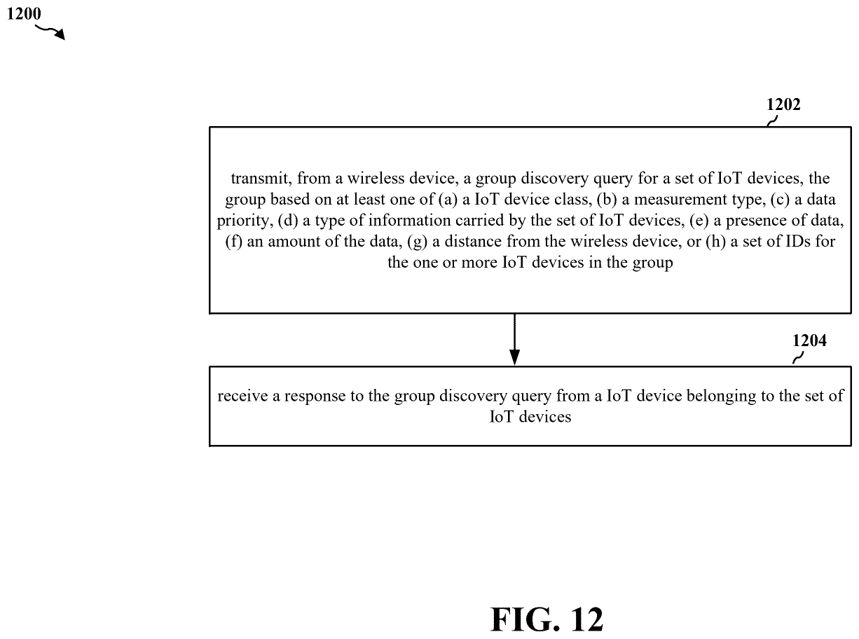

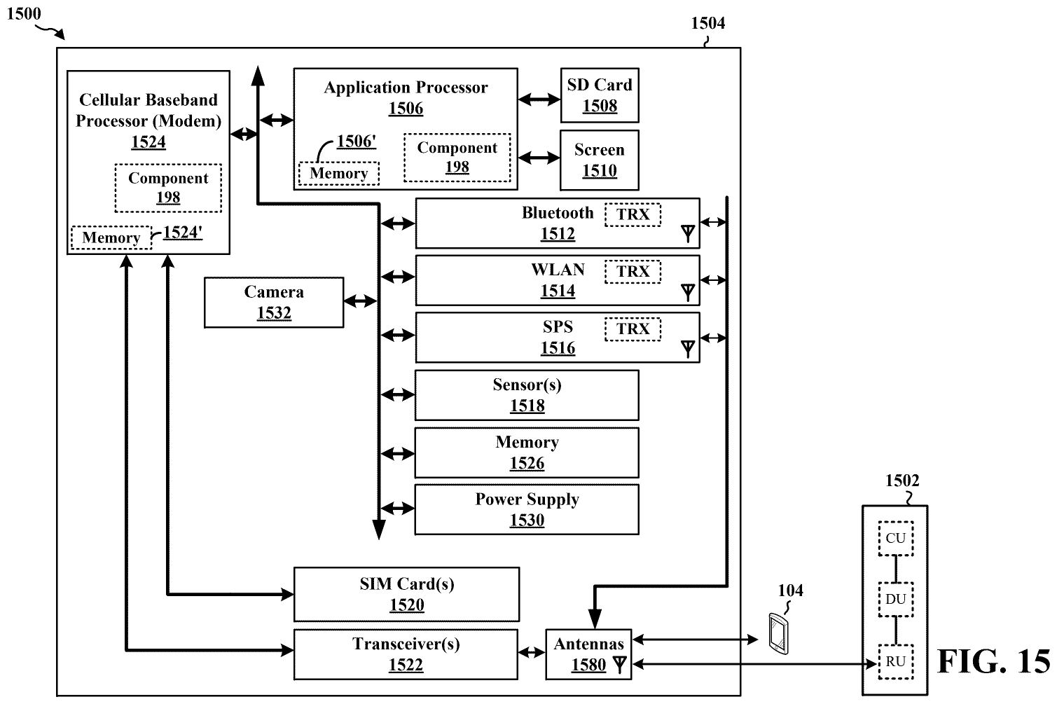

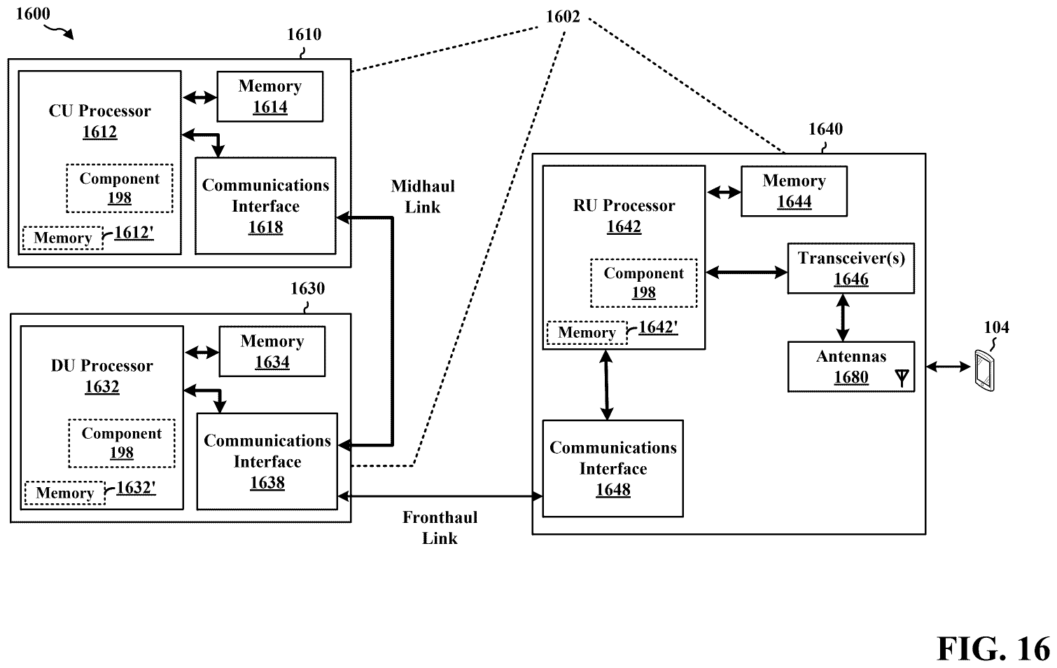

FIG. 12 is a flowchart 1200 of a method of wireless communication. The method may be performed by a wireless device (e.g., the UE 104, the RF source 412, the RF reader 414; the RF source 610; the wireless device 350, the wireless device 802; the apparatus 1504; the base station 102; the network entity 1502, the network entity 1602, the network entity 1760). At 1002, the wireless device may transmit a group discovery query for a set of IoT devices, the group based on at least one of (a) a IoT device class, (b) a measurement type, (c) a data priority, (d) a type of information carried by the set of IoT devices, (e) a presence of data, (f) an amount of the data, (g) a distance from the wireless device, or (h) a set of IDs for the one or more IoT devices in the group. For example, 1202 may be performed by the wireless device 802 in FIG. 8, which may transmit a discovery query 808 for a set of IoT devices to the IoTD 804. The group may be based on at least one of (a) a IoT device class, (b) a measurement type, (c) a data priority, (d) a type of information carried by the set of IoT devices, (e) a presence of data, (f) an amount of the data, (g) a distance from the wireless device, or (h) a set of IDs for the one or more IoT devices in the group. Moreover, 1202 may be performed by the component 198 in FIGS. 15-16.

At 1204, the wireless device may receive a response to the group discovery query from an IoT device belonging to the set of IoT devices. For example, 1204 may be performed by the wireless device 802 in FIG. 8, which may receive a query response 814 to the discovery query 808 from the IoTD 804 belonging to the set of IoT devices. Moreover, 1204 may be performed by the component 198 in FIGS. 15-16.

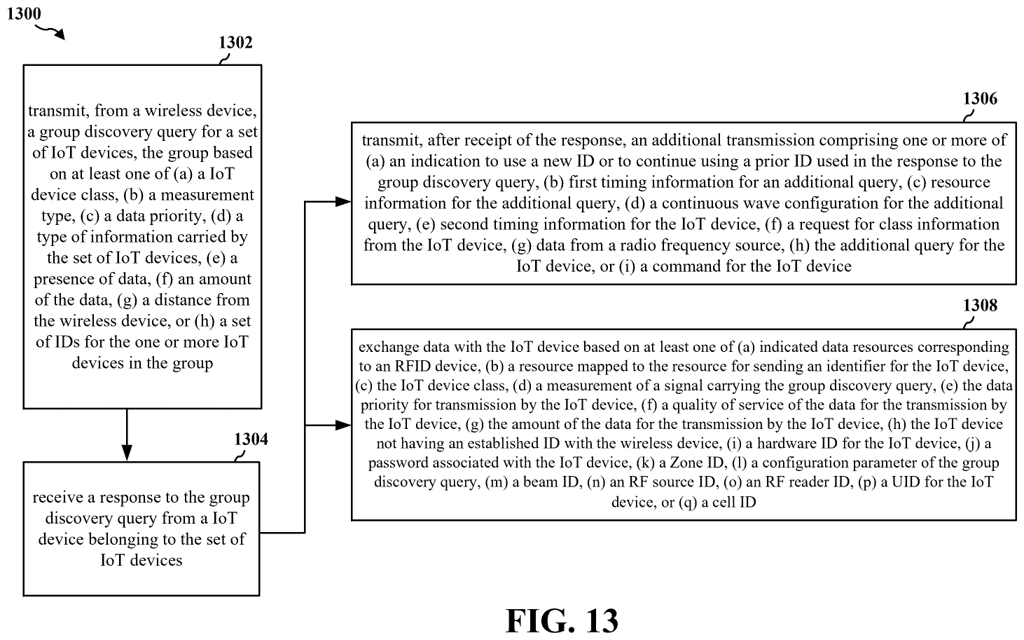

FIG. 13 is a flowchart 1300 of a method of wireless communication. The method may be performed by a wireless device (e.g., the UE 104, the RF source 412, the RF reader 414; the RF source 610; the wireless device 350, the wireless device 802; the apparatus 1504; the base station 102; the network entity 1502, the network entity 1602, the network entity 1760). At 1002, the wireless device may transmit a group discovery query for a set of IoT devices, the group based on at least one of (a) a IoT device class, (b) a measurement type, (c) a data priority, (d) a type of information carried by the set of IoT devices, (e) a presence of data, (f) an amount of the data, (g) a distance from the wireless device, or (h) a set of IDs for the one or more IoT devices in the group. For example, 1302 may be performed by the wireless device 802 in FIG. 8, which may transmit a discovery query 808 for a set of IoT devices to the IoTD 804. The group may be based on at least one of (a) a IoT device class, (b) a measurement type, (c) a data priority, (d) a type of information carried by the set of IoT devices, (e) a presence of data, (f) an amount of the data, (g) a distance from the wireless device, or (h) a set of IDs for the one or more IoT devices in the group. Moreover, 1302 may be performed by the component 198 in FIGS. 15-16.

At 1304, the wireless device may receive a response to the group discovery query from an IoT device belonging to the set of IoT devices. For example, 1304 may be performed by the wireless device 802 in FIG. 8, which may receive a query response 814 to the discovery query 808 from the IoTD 804 belonging to the set of IoT devices. Moreover, 1304 may be performed by the component 198 in FIGS. 15-16.

At 1306, the wireless device may transmit, after receipt of the response, an additional transmission including one or more of (a) an indication to use a new ID or to continue using a prior ID used in the response to the group discovery query, (b) first timing information for an additional query, (c) resource information for the additional query, (d) a continuous wave configuration for the additional query, (e) second timing information for the IoT device, (f) a request for class information from the IoT device, (g) data from a radio frequency source, (h) the additional query for the IoT device, or (i) a command for the IoT device. For example, 1306 may be performed by the wireless device 802 in FIG. 8, which may transmit one or more transmissions with the IoTD 804 as backscatter communication 818 after receipt of the query response 814. The one or more transmissions may include one or more of (a) an indication to use a new ID or to continue using a prior ID used in the response to the group discovery query, (b) first timing information for an additional query, (c) resource information for the additional query, (d) a continuous wave configuration for the additional query, (e) second timing information for the IoT device, (f) a request for class information from the IoT device, (g) data from a radio frequency source, (h) the additional query for the IoT device, or (i) a command for the IoT device. Moreover, 1306 may be performed by the component 198 in FIGS. 15-16.

At 1308, the wireless device may exchange data with the IoT device based on at least one of (a) indicated data resources corresponding to an RFID device, (b) a resource mapped to the resource for sending an identifier for the IoT device, (c) the IoT device class, (d) a measurement of a signal carrying the group discovery query, (e) the data priority for transmission by the IoT device, (f) a quality of service of the data for the transmission by the IoT device, (g) the amount of the data for the transmission by the IoT device, (h) the IoT device not having an established ID with the wireless device, (i) a hardware ID for the IoT device, (j) a password associated with the IoT device, (k) a Zone ID, (l) a configuration parameter of the group discovery query, (m) a beam ID, (n) an RF source ID, (o) an RF reader ID, (p) a UID for the IoT device, or (q) a cell ID. For example, 1308 may be performed by the wireless device 802 in FIG. 8, which may exchange data with the IoTD 804 as backscatter communication 818. The backscatter communication 818 may be based on at least one of (a) indicated data resources corresponding to an RFID device, (b) a resource mapped to the resource for sending an identifier for the IoT device, (c) the IoT device class, (d) a measurement of a signal carrying the group discovery query, (e) the data priority for transmission by the IoT device, (f) a quality of service of the data for the transmission by the IoT device, (g) the amount of the data for the transmission by the IoT device, (h) the IoT device not having an established ID with the wireless device 802, (i) a hardware ID for the IoT device, (j) a password associated with the IoT device, (k) a Zone ID, (l) a configuration parameter of the group discovery query, (m) a beam ID, (n) an RF source ID, (o) an RF reader ID, (p) a UID for the IoT device, or (q) a cell ID. Moreover, 1308 may be performed by the component 198 in FIGS. 15-16.

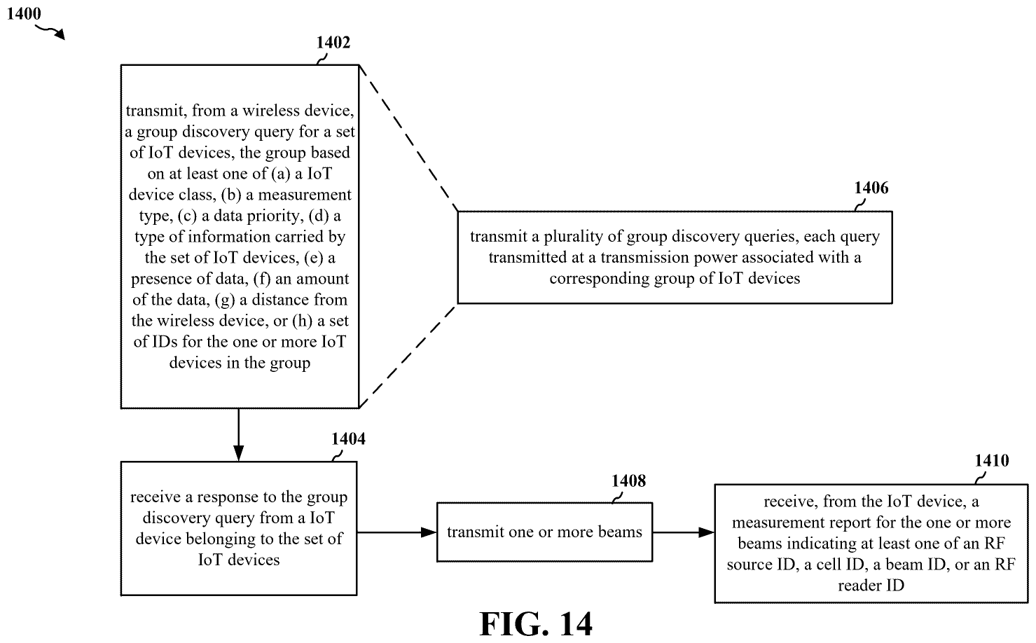

FIG. 14 is a flowchart 1400 of a method of wireless communication. The method may be performed by a wireless device (e.g., the UE 104, the RF source 412, the RF reader 414; the RF source 610; the wireless device 350, the wireless device 802; the apparatus 1504; the base station 102; the network entity 1502, the network entity 1602, the network entity 1760). At 1002, the wireless device may transmit a group discovery query for a set of IoT devices, the group based on at least one of (a) a IoT device class, (b) a measurement type, (c) a data priority, (d) a type of information carried by the set of IoT devices, (e) a presence of data, (f) an amount of the data, (g) a distance from the wireless device, or (h) a set of IDs for the one or more IoT devices in the group. For example, 1402 may be performed by the wireless device 802 in FIG. 8, which may transmit a discovery query 808 for a set of IoT devices to the IoTD 804. The group may be based on at least one of (a) a IoT device class, (b) a measurement type, (c) a data priority, (d) a type of information carried by the set of IoT devices, (e) a presence of data, (f) an amount of the data, (g) a distance from the wireless device, or (h) a set of IDs for the one or more IoT devices in the group. Moreover, 1402 may be performed by the component 198 in FIGS. 15-16.

At 1404, the wireless device may receive a response to the group discovery query from an IoT device belonging to the set of IoT devices. For example, 1404 may be performed by the wireless device 802 in FIG. 8, which may receive a query response 814 to the discovery query 808 from the IoTD 804 belonging to the set of IoT devices.

At 1406, the wireless device may transmit a plurality of group discovery queries. Each query may be transmitted at a transmission power associated with a corresponding group of IoT devices. For example, 1406 may be performed by the wireless device 802 in FIG. 8, which may transmit a plurality of group discovery queries, one of which includes the discovery query 808 received by the IoTD 804. Each of the discovery queries may be transmitted at a transmission power associated with a corresponding group of IoT devices. For example, a first discovery query may be transmitted at a first transmission power associated with a first IoT device class, and a second discovery query may be transmitted at a second transmission power associated with the second IoT device class. The first discovery query may have a lower power than the second discovery query, so the IoTD 804 may be unable to receive and read the first discovery query as it may not be strong enough to power the IoTD 804. The IoTD 804 may be associated with the second IoT device class, and the second discovery query may be strong enough to activate the IoTD 804. The second discovery query may be the discovery query 808 received by the IoTD 804. Moreover, 1406 may be performed by the component 198 in FIGS. 15-16.

At 1408, the wireless device may transmit one or more beams. For example, 1408 may be performed by the wireless device 802 in FIG. 8, which may transmit one or more beams, such as the discovery query 808 and the backscatter communication 818. The wireless device 802 may periodically output discovery queries over a period of time. Moreover, 1408 may be performed by the component 198 in FIGS. 15-16.

At 1410, the wireless device may receive, from the IoT device, a measurement report for the one or more beams indicating at least one of an RF source ID, a cell ID, a beam ID, or an RF reader ID. For example, 1410 may be performed by the wireless device 802 in FIG. 8, which may receive, from the IoTD 804, a measurement report for the one or more beams as the backscatter communication 818. The report may indicate at least one of an RF source ID, a cell ID, a beam ID, or an RF reader ID. In some aspects, the measurement report may be transmitted to the network node 801, the wireless device 802, the wireless device 803, or another UE, for the one or more beams. The receiving device may use the measurement report indicating at least one of an RF source ID, a cell ID, a beam ID, or an RF reader ID to determine a best RF source and RF reader pairing with respect to the IoTD 804. Moreover, 1410 may be performed by the component 198 in FIGS. 15-16.

FIG. 15 is a diagram 1500 illustrating an example of a hardware implementation for an apparatus 1504. The apparatus 1504 may be a UE, a component of a UE, or may implement UE functionality. In some aspects, the apparatus 1404 may include a cellular baseband processor 1524 (also referred to as a modem) coupled to one or more transceivers 1522 (e.g., cellular RF transceiver). The cellular baseband processor 1524 may include on-chip memory 1524′. In some aspects, the apparatus 1504 may further include one or more subscriber identity modules (SIM) cards 1520 and an application processor 1506 coupled to a secure digital (SD) card 1508 and a screen 1510. The application processor 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), memory 1526, a power supply 1530, and/or a camera 1532. The Bluetooth module 1512, the WLAN module 1514, and the SPS module 1516 may include an on-chip transceiver (TRX) (or in some cases, just a receiver). The Bluetooth module 1512, the WLAN module 1514, and the SPS module 1516 may include their own dedicated antennas and/or utilize the antennas 1580 for communication. The cellular baseband processor 1524 communicates through the transceiver(s) 1522 via one or more antennas 1580 with the UE 104 and/or with an RU associated with a network entity 1502. The cellular baseband processor 1524 and the application processor 1506 may each include a computer-readable medium/memory 1524′, 1506′, respectively. The memory 1526 may also be considered a computer-readable medium/memory. Each computer-readable medium/memory 1524′, 1506′, 1526 may be non-transitory. The cellular baseband processor 1524 and the application processor 1506 are each responsible for general processing, including the execution of software stored on the computer-readable medium/memory. The software, when executed by the cellular baseband processor 1524/application processor 1506, causes the cellular baseband processor 1524/application processor 1506 to perform the various functions described supra. The computer-readable medium/memory may also be used for storing data that is manipulated by the cellular baseband processor 1524/application processor 1506 when executing software. The cellular baseband processor 1524/application processor 1506 may be a component of the wireless device 350 and may include the memory 360 and/or at least one of the Tx processor 368, the Rx processor 356, and the controller/processor 359. In one configuration, the apparatus 1504 may be a processor chip (modem and/or application) and include just the cellular baseband processor 1524 and/or the application processor 1506, and in another configuration, the apparatus 1504 may be the entire UE (e.g., the wireless device 350 of FIG. 3) and include the additional modules of the apparatus 1504.

As discussed supra, the component 198 may be configured to transmit a group discovery query for a set of IoT devices. The group may be based on at least one of (a) an IoT device class, (b) a measurement type, (c) a data priority, (d) a type of information carried by the set of IoT devices, (e) a presence of data, (f) an amount of the data, (g) a distance from the apparatus 1504, or (h) a set of identifiers for the one or more IoT devices in the group. The component 198 may be configured to receive a response to the group discovery query from an IoT device belonging to the set of IoT devices. The component 198 may be within the cellular baseband processor 1524, the application processor 1506, or both the cellular baseband processor 1524 and the application processor 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1504 may include a variety of components configured for various functions. In one configuration, the apparatus 1504, and in particular the cellular baseband processor 1524 and/or the application processor 1506, may include means for receiving a group discovery query for a set of IoT devices. The apparatus 1504 may include means for transmitting a response to the group discovery query based on the IoT device belonging to the set of IoT devices. The apparatus 1504 may include means for receiving, prior to receipt of the group discovery query, a configuration indicating the resource for IoT devices without the established ID with apparatus 1504. The apparatus 1504 may include means for scrambling the response using an RFID device ID for the IoT device. The apparatus 1504 may include means for scrambling the response using an ID from a set for IoT devices without the established ID with the apparatus 1504. The apparatus 1504 may include means for receiving, after the response, an additional transmission including one or more of (a) an indication to use a new ID or to continue using a prior ID used in the response to the group discovery query, (b) first timing information for an additional query, (c) resource information for the additional query, (d) a continuous wave configuration for the additional query, (e) second timing information for the IoT device, (f) a request for class information from the IoT device, (g) data from a radio frequency source, (h) the additional query for the IoT device, or (i) a command for the IoT device. The apparatus 1504 may include means for exchanging data with the apparatus 1504 device based on at least one of (a) indicated data resources corresponding to an RFID device, (b) a resource mapped to the resource for sending an identifier for the IoT device, (c) the IoT device class, (d) a measurement of a signal carrying the group discovery query, (e) the data priority for transmission by the IoT device, (f) a quality of service of the data for the transmission by the IoT device, (g) the amount of the data for the transmission by the IoT device, (h) the IoT device not having an established ID with the apparatus 1504, (i) a hardware ID for the IoT device, (j) a password associated with the IoT device, (k) a Zone ID, (l) a configuration parameter of the group discovery query, (m) a beam ID, (n) an RF source ID, (o) an RF reader ID, (p) a UID for the IoT device, or (q) a cell ID. The apparatus 1504 may include means for considering a previous ID with a source of the group discovery query to be expired based on at least one of (a) a timer expiration, (b) passage of a duration of time, (c) completion of a read connection, or (d) an indication in write or read session from the apparatus 1504 or an RF reader indicating a connection expiration. The apparatus 1504 may include means for measuring one or more beams. The apparatus 1504 may include means for reporting measurement of the one or more beams indicating at least one of an RF source ID, a cell ID, a beam ID, or an RF reader ID. The means may be the component 198 of the apparatus 1504 configured to perform the functions recited by the means. As described supra, the apparatus 1504 may include the Tx processor 368, the Rx processor 356, and the controller/processor 359. As such, in one configuration, the means may be the Tx processor 368, the Rx processor 356, and/or the controller/processor 359 configured to perform the functions recited by the means.

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 198, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include a CU processor 1612. The CU processor 1612 may include on-chip memory 1612′. In some aspects, the CU 1610 may further include memory 1614 and a communications interface 1618. The CU 1610 communicates with the DU 1630 through a midhaul link, such as an F1 interface. The DU 1630 may include a DU processor 1632. The DU processor 1632 may include on-chip memory 1632′. In some aspects, the DU 1630 may further include memory 1634 and a communications interface 1638. The DU 1630 communicates with the RU 1640 through a fronthaul link. The RU 1640 may include an RU processor 1642. The RU processor 1642 may include on-chip memory 1642′. In some aspects, the RU 1640 may further include memory 1644, one or more transceivers 1646, antennas 1680, and a communications interface 1648. The RU 1640 communicates with the UE 104. The on-chip memory 1612′, 1632′, 1642′ and the memory 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to transmit a group discovery query for a set of IoT devices. The group may be based on at least one of (a) an IoT device class, (b) a measurement type, (c) a data priority, (d) a type of information carried by the set of IoT devices, (e) a presence of data, (f) an amount of the data, (g) a distance from a radio frequency (RF) source device, or (h) a set of identifiers for the one or more IoT devices in the group. The component 198 may be configured to receive a response to the group discovery query from an IoT device belonging to the set of IoT devices. The component 198 may be within one or more processors of one or more of the CU 1610, DU 1630, and the RU 1640. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1602 may include a variety of components configured for various functions. In one configuration, the network entity 1602 includes means for receiving a group discovery query for a set of IoT devices. The network entity 1602 may include means for transmitting a response to the group discovery query based on the IoT device belonging to the set of IoT devices. The network entity 1602 may include means for receiving, prior to receipt of the group discovery query, a configuration indicating the resource for IoT devices without the established ID with the RF source device. The network entity 1602 may include means for scrambling the response using an RFID device ID for the IoT device. The network entity 1602 may include means for scrambling the response using an ID from a set for IoT devices without the established ID with the RF source device. The network entity 1602 may include means for receiving, after the response, an additional transmission including one or more of (a) an indication to use a new ID or to continue using a prior ID used in the response to the group discovery query, (b) first timing information for an additional query, (c) resource information for the additional query, (d) a continuous wave configuration for the additional query, (e) second timing information for the IoT device, (f) a request for class information from the IoT device, (g) data from a radio frequency source, (h) the additional query for the IoT device, or (i) a command for the IoT device. The network entity 1602 may include means for exchanging data with the RF source device based on at least one of (a) indicated data resources corresponding to an RFID device, (b) a resource mapped to the resource for sending an identifier for the IoT device, (c) the IoT device class, (d) a measurement of a signal carrying the group discovery query, (e) the data priority for transmission by the IoT device, (f) a quality of service of the data for the transmission by the IoT device, (g) the amount of the data for the transmission by the IoT device, (h) the IoT device not having an established ID with the RF source device, (i) a hardware ID for the IoT device, (j) a password associated with the IoT device, (k) a Zone ID, (l) a configuration parameter of the group discovery query, (m) a beam ID, (n) an RF source ID, (o) an RF reader ID, (p) a UID for the IoT device, or (q) a cell ID. The network entity 1602 may include means for considering a previous ID with a source of the group discovery query to be expired based on at least one of (a) a timer expiration, (b) passage of a duration of time, (c) completion of a read connection, or (d) an indication in write or read session from an RF source or an RF reader indicating a connection expiration. The network entity 1602 may include means for measuring one or more beams. The network entity 1602 may include means for reporting measurement of the one or more beams indicating at least one of an RF source ID, a cell ID, a beam ID, or an RF reader ID. The means may be the component 198 of the network entity 1602 configured to perform the functions recited by the means. As described supra, the network entity 1602 may include the Tx processor 368, the Rx processor 356, and the controller/processor 359. As such, in one configuration, the means may be the Tx processor 368, the Rx processor 356, and/or the controller/processor 359 configured to perform the functions recited by the means.

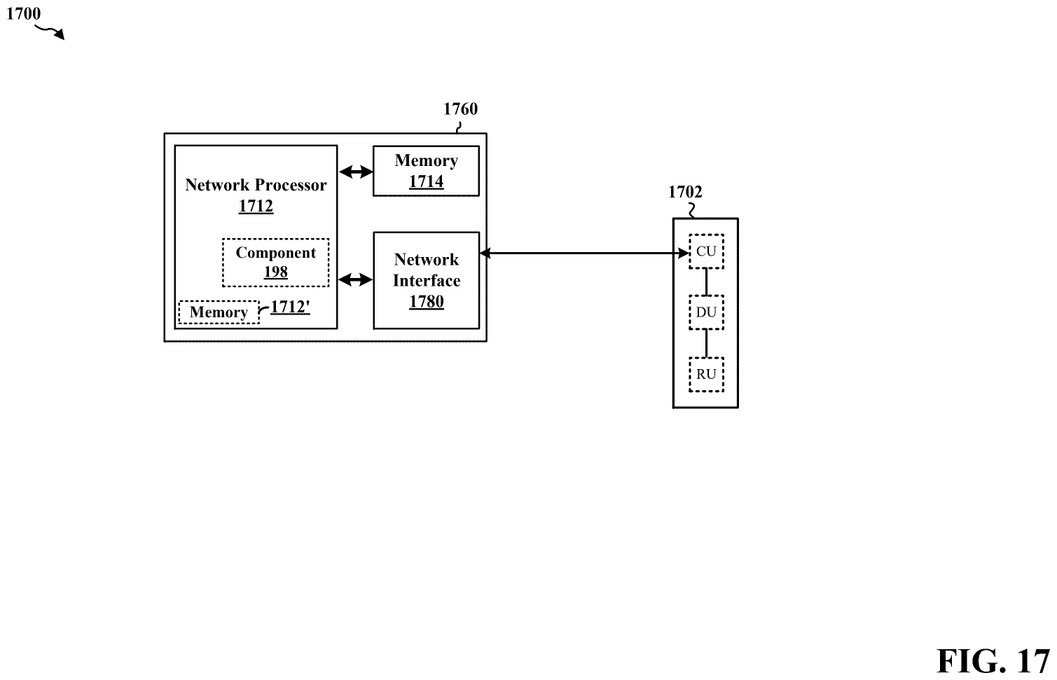

FIG. 17 is a diagram 1700 illustrating an example of a hardware implementation for a network entity 1760. In one example, the network entity 1760 may be within the core network 130. The network entity 1760 may include a network processor 1712. The network processor 1712 may include on-chip memory 1712′. In some aspects, the network entity 1760 may further include memory 1714. The network entity 1760 communicates via the network interface 1780 directly (e.g., backhaul link) or indirectly (e.g., through a RIC) with the CU 1702. The on-chip memory 1712′ and the memory 1714 may each be considered a computer-readable medium/memory. Each computer-readable medium/memory may be non-transitory. The processor 1712 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to transmit a group discovery query for a set of IoT devices. The group may be based on at least one of (a) an IoT device class, (b) a measurement type, (c) a data priority, (d) a type of information carried by the set of IoT devices, (e) a presence of data, (f) an amount of the data, (g) a distance from a radio frequency (RF) source device, or (h) a set of identifiers for the one or more IoT devices in the group. The component 198 may be configured to receive a response to the group discovery query from an IoT device belonging to the set of IoT devices. The component 198 may be within the processor 1712. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1760 may include a variety of components configured for various functions. In one configuration, the network entity 1760 includes means for transmitting a response to the group discovery query based on the IoT device belonging to the set of IoT devices. The network entity 1760 may include means for receiving, prior to receipt of the group discovery query, a configuration indicating the resource for IoT devices without the established ID with the RF source device. The network entity 1760 may include means for scrambling the response using an RFID device ID for the IoT device. The network entity 1760 may include means for scrambling the response using an ID from a set for IoT devices without the established ID with the RF source device. The network entity 1760 may include means for receiving, after the response, an additional transmission including one or more of (a) an indication to use a new ID or to continue using a prior ID used in the response to the group discovery query, (b) first timing information for an additional query, (c) resource information for the additional query, (d) a continuous wave configuration for the additional query, (e) second timing information for the IoT device, (f) a request for class information from the IoT device, (g) data from a radio frequency source, (h) the additional query for the IoT device, or (i) a command for the IoT device. The network entity 1760 may include means for exchanging data with the RF source device based on at least one of (a) indicated data resources corresponding to an RFID device, (b) a resource mapped to the resource for sending an identifier for the IoT device, (c) the IoT device class, (d) a measurement of a signal carrying the group discovery query, (e) the data priority for transmission by the IoT device, (f) a quality of service of the data for the transmission by the IoT device, (g) the amount of the data for the transmission by the IoT device, (h) the IoT device not having an established ID with the RF source device, (i) a hardware ID for the IoT device, (j) a password associated with the IoT device, (k) a Zone ID, (l) a configuration parameter of the group discovery query, (m) a beam ID, (n) an RF source ID, (o) an RF reader ID, (p) a UID for the IoT device, or (q) a cell ID. The network entity 1760 may include means for considering a previous ID with a source of the group discovery query to be expired based on at least one of (a) a timer expiration, (b) passage of a duration of time, (c) completion of a read connection, or (d) an indication in a write or a read session from an RF source, an RF reader, or a wireless device indicating a connection expiration. The network entity 1760 may include means for measuring one or more beams. The network entity 1760 may include means for reporting measurement of the one or more beams indicating at least one of an RF source ID, a cell ID, a beam ID, or an RF reader ID. The means may be the component 198 of the network entity 1760 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data.

The following aspects are illustrative only and may be combined with other aspects or teachings described herein, without limitation.

Aspect 1 is a method of wireless communication at a UE, where the method may include receiving a group discovery query for a set of IoT devices from an RF source device. The group may be based on at least one of (a) an IoT device class, (b) a measurement type, (c) a data priority, (d) a type of information carried by the set of IoT devices, (e) a presence of data, (f) an amount of the data, (g) a distance from the RF source device, or (h) a set of IDs for the one or more IoT devices in the group. The method may include transmitting a response to the group discovery query based on the IoT device belonging to the set of IoT devices.

Aspect 2 is the method of aspect 1, where the distance from the RF source device may be based on at least one of (a) a charging rate, (b) an RSRP, (c) an RSRQ, (d) an SNR, (e) a pathloss, (f) a received power of the group discovery query, or (g) a zone.

Aspect 3 is the method of any of aspects 1 and 2, where the response to the group discovery query may indicate an ID for the IoT device that was previously established between the IoT device and the RF source device.

Aspect 4 is the method of any of aspects 1 to 3, where the response to the group discovery query may indicate an ID indicating that the IoT device does not have an established ID with the RF source device. The ID may include at least one of an invalid ID or the ID selected from a set of IDs for unknown IoT devices.

Aspect 5 is the method of any of aspects 1 to 4, where the response to the group discovery query may be in a resource indicating that the IoT device does not have an established ID with the RF source device.

Aspect 6 is the method of aspect 5, where the method may include receiving, prior to receipt of the group discovery query, a configuration indicating the resource for IoT devices without the established ID with the RF source device.

Aspect 7 is the method of any of aspects 5 to 6, where the group discovery query may include an indication of the resource for IoT devices without the established ID with the RF source device.

Aspect 8 is the method of any of aspects 5 to 7, where the method may include scrambling the response using an RFID device ID for the IoT device.

Aspect 9 is the method of any of aspects 5 to 8, where the method may include scrambling the response using an ID from a set for IoT devices without the established ID with the RF source device.

Aspect 10 is the method of any of aspects 1 to 9, where at least one of a resource, a time, an offset, a scrambling sequence, or an IoT device ID for the response to the group discovery query may be based on one or more of (a) the IoT device class, (b) a measurement of a signal carrying the group discovery query, (c) the data priority for transmission by the IoT device, (d) a quality of service of the data for the transmission by the IoT device, (e) the amount of the data for the transmission by the IoT device, (f) the IoT device not having an established ID with the RF source device, (g) a hardware ID for the IoT device, (h) a password associated with the IoT device, (i) a Zone ID, (j) a configuration parameter of the group discovery query, (k) a beam ID, (l) an RF source ID, (m) an RF reader ID, (n) a UID for the IoT device, or (o) a cell ID.

Aspect 11 is the method of aspect 10, where the group discovery query may include a parameter, where the response to the group discovery query may be on the resource associated with the set of IoT devices. The response to the group discovery query may be based on the parameter in the group discovery query.

Aspect 12 is the method of any of aspects 1 to 11, where the method may include receiving, after the response, an additional transmission including one or more of (a) an indication to use a new ID or to continue using a prior ID used in the response to the group discovery query, (b) first timing information for an additional query, (c) resource information for the additional query, (d) a continuous wave configuration for the additional query, (e) second timing information for the IoT device, (f) a request for class information from the IoT device, (g) data from a radio frequency source, (h) the additional query for the IoT device, or (i) a command for the IoT device. The continuous wave configuration for the additional query may include at least one of a time, a frequency, a type of waveform, a type of modulation, or a type of coding.

Aspect 13 is the method of any of aspects 1 to 12, where the method may include exchanging data with the RF source device based on at least one of (a) indicated data resources corresponding to an RFID device, (b) a resource mapped to the resource for sending an identifier for the IoT device, (c) the IoT device class, (d) a measurement of a signal carrying the group discovery query, (e) the data priority for transmission by the IoT device, (f) a quality of service of the data for the transmission by the IoT device, (g) the amount of the data for the transmission by the IoT device, (h) the IoT device not having an established ID with the RF source device, (i) a hardware ID for the IoT device, (j) a password associated with the IoT device, (k) a Zone ID, (l) a configuration parameter of the group discovery query, (m) a beam ID, (n) an RF source ID, (o) an RF reader ID, or (p) a cell ID.

Aspect 14 is the method of any of aspects 1 to 13, where the method may include considering a previous ID with a source of the group discovery query to be expired based on at least one of (a) a timer expiration, (b) passage of a duration of time, (c) completion of a read connection, or (d) an indication in a write or a read session from an RF source, an RF reader, or a wireless device indicating a connection expiration. The wireless device may be a base station or a third UE.

Aspect 15 is the method of any of aspects 1 to 14, where the group discovery query may be received in a beamformed signal from the RF source device and carries beam information.

Aspect 16 is the method of any of aspects 1 to 15, where the response may include the beam information and one or more of an RF source ID or an IoT device ID.

Aspect 17 is the method of aspect 16, where the response may be transmitted in a resource based on a beam ID, the RF source ID, the IoT device ID, an RF reader ID, or a cell ID.

Aspect 18 is the method of aspect 15, where the method may include measuring one or more beams. The method may include reporting measurement of the one or more beams indicating at least one of an RF source ID, a beam ID, an RF reader ID, or a cell ID.

Aspect 19 is a method of wireless communication at a wireless device, where the method may include transmitting a group discovery query for a set of IoT devices. The group may be based on at least one of (a) an IoT device class, (b) a measurement type, (c) a data priority, (d) a type of information carried by the set of IoT devices, (e) a presence of data, (f) an amount of the data, (g) a distance from the wireless device, or (h) a set of identifiers for the one or more IoT devices in the group. The method may include receiving a response to the group discovery query from an IoT device belonging to the set of IoT devices.

Aspect 20 is the method of aspect 19, where transmitting the group discovery query for the set of IoT devices may include transmitting multiple group discovery queries. Each query may be transmitted at a transmission power associated with a corresponding group of IoT devices.

Aspect 21 is the method of any of aspects 19 and 20, where the set of IoT devices may be based on the distance from the wireless device. The distance may be based on at least one of a charging rate, an RSRP, a pathloss, a received power of the group discovery query, or a zone.

Aspect 22 is the method of any of aspects 19 to 23, where the response to the group discovery query may include an ID for the IoT device that was previously established between the IoT device and the wireless device.

Aspect 23 is the method of any of aspects 19 to 23, where the response to the group discovery query may indicate an ID indicating that the IoT device does not have an established ID with the wireless device. The ID may include at least one of (a) an invalid ID, or (b) the ID selected from a set of IDs for unknown IoT devices.

Aspect 24 is the method of any of aspects 19 to 23, where the response to the group discovery query may be in a resource indicating that the IoT device does not have an established ID with the wireless device.

Aspect 25 is the method of aspect 24, where the method may include transmitting, prior to the group discovery query, a configuration indicating the resource for IoT devices without the established ID with the wireless device.

Aspect 26 is the method of any of aspects 24 to 25, where the method may include transmitting, in the group discovery query, an indication of the resource for IoT devices without the established ID with the wireless device.

Aspect 27 is the method of any of aspects 19 to 26, where at least one of a resource, a time, an offset, a scrambling sequence, or an IoT device ID for the response to the group discovery query may be based on one or more of (a) the IoT device class, (b) a measurement of a signal carrying the group discovery query, (c) the data priority for transmission by the IoT device, (d) a quality of service of the data for the transmission by the IoT device, (e) the amount of the data for the transmission by the IoT device, (f) the IoT device not having an established ID with the wireless device, (g) a hardware ID for the IoT device, (h) a password associated with the IoT device, (i) a Zone ID, (j) a configuration parameter of the group discovery query, (k) a beam ID, (l) an RF source ID, (m) an RF reader ID, (o) a UID for the IoT device, or (p) a cell ID.

Aspect 28 is the method of any of aspects 19 to 27, where the group discovery query may include a parameter. The response to the group discovery query may be on the resource associated with the set of IoT devices and is based on the parameter in the group discovery query.

Aspect 29 is the method of any of aspects 19 to 28, where the method may include transmitting, after receipt of the response, an additional transmission including one or more of (a) an indication to use a new ID or to continue using a prior ID used in the response to the group discovery query, (b) first timing information for an additional query, (c) resource information for the additional query, (d) a continuous wave configuration for the additional query, (e) second timing information for the IoT device, (f) a request for class information from the IoT device, (g) data from a radio frequency source, (h) the additional query for the IoT device, or (i) a command for the IoT device. The continuous wave configuration for the additional query may include at least one of a time, a frequency, a type of waveform, a type of modulation, or a type of coding.

Aspect 30 is the method of any of aspects 19 to 29, where the method may include exchanging data with the IoT device based on at least one of (a) indicated data resources corresponding to an RFID device, (b) a resource mapped to the resource for sending an identifier for the IoT device, (c) the IoT device class, (d) a measurement of a signal carrying the group discovery query, (e) the data priority for transmission by the IoT device, (f) a quality of service of the data for the transmission by the IoT device, (g) the amount of the data for the transmission by the IoT device, (h) the IoT device not having an established ID with the wireless device, (i) a hardware ID for the IoT device, (j) a password associated with the IoT device, (k) a Zone ID, (l) an RF configuration parameter of the group discovery query, (m) a beam ID, (n) an RF source ID, (o) an RF reader ID, (p) a UID for the IoT device, or (q) a cell ID.

Aspect 31 is the method of any of aspects 19 to 30, where the group discovery query may be transmitted in a beamformed signal from the wireless device and carries beam information. The response may include the beam information and one or more of a cell ID, an RF source ID or an IoT device ID.

Aspect 32 is the method of any of aspects 19 to 31, where the response may be received in a resource based on a beam ID, the RF source ID, the IoT device ID, an RF reader ID, or a cell ID.

Aspect 33 is the method of any of aspects 19 to 32, where the method may include transmitting one or more beams. The method may include receiving, from the IoT device, a measurement report for the one or more beams indicating at least one of an RF source ID, a cell ID, a beam ID, or an RF reader ID.

Aspect 34 is the method of any of aspects 1 to 18, where the one or more IoT devices may include an RFID tag device, a backscattering-based communications device, a UE including the RFID tag device, or a UE including the backscattering-based communications device.

Aspect 35 is the method of aspect 1, where the method may include transmitting a capability to maintain a timing of the IoT device.

Aspect 36 is the method of aspect 35, where transmitting the capability to maintain the timing of the IoT device may be in response to receiving the group discovery query.

Aspect 37 is an apparatus for wireless communication, including: a memory; and at least one processor coupled to the memory and, based at least in part on information stored in the memory, the at least one processor is configured to implement any of aspects 1 to 36.

Aspect 38 is the apparatus of aspect 37, further including at least one of an antenna or a transceiver coupled to the at least one processor.

Aspect 39 is an apparatus for wireless communication including means for implementing any of aspects 1 to 36.

Aspect 40 is a computer-readable medium (e.g., a non-transitory computer-readable medium) storing computer executable code, where the code when executed by a processor causes the processor to implement any of aspects 1 to 36.

What is claimed is:

1. An apparatus for wireless communication at an IoT device, comprising:
a memory; and
at least one processor coupled to the memory and, based at least in part on information stored in the memory, the at least one processor is configured to:
receive a group discovery query for a set of Internet-of-things (IoT) devices from a radio frequency (RF) source device, the set of IoT devices based on at least one of (a) an IoT device class, (b) a measurement type, (c) a data priority, (d) a type of information carried by the set of IoT devices, (e) a presence of data, (f) an amount of the data, (g) a distance from the RF source device, or (h) a set of identifiers (IDs) for the set of IoT devices; and
transmit a response to the group discovery query based on the IoT device belonging to the set of IoT devices.

2. The apparatus of claim 1, wherein the distance from the RF source device is based on at least one of (a) a charging rate, (b) a reference signal received power (RSRP), (c) a reference signal received quality (RSRQ), (d) a signal-to-noise ratio (SNR), (e) a pathloss, (f) a received power of the group discovery query, or (g) a zone.

3. The apparatus of claim 1, further comprising a transceiver coupled to the at least one processor, wherein the response to the group discovery query is transmitted using the transceiver, wherein the response to the group discovery query indicates an identifier (ID) for the IoT device that was previously established between the IoT device and the RF source device.

4. The apparatus of claim 1, wherein the response to the group discovery query indicates an identifier (ID) indicating that the IoT device does not have an established ID with the RF source device, the ID comprising at least one of:
an invalid ID, or
the ID selected from a set of IDs for unknown IoT devices.

5. The apparatus of claim 1, wherein the response to the group discovery query is in a resource indicating that the IoT device does not have an established ID with the RF source device.

6. The apparatus of claim 5, wherein the at least one processor is further configured to:
receive, prior to receipt of the group discovery query, a configuration indicating the resource for IoT devices without the established ID with the RF source device.

7. The apparatus of claim 5, wherein the group discovery query comprises an indication of the resource for IoT devices without the established ID with the RF source device.

8. The apparatus of claim 5, wherein the at least one processor is further configured to:
scramble the response using a radio frequency identifier (RFID) device ID for the IoT device.

9. The apparatus of claim 5, wherein the at least one processor is further configured to:
scramble the response using an ID from a set for IoT devices without the established ID with the RF source device.

10. The apparatus of claim 1, wherein at least one of a resource, a time, an offset, a scrambling sequence, or an IoT device ID for the response to the group discovery query is based on one or more of:
the IoT device class,
a measurement of a signal carrying the group discovery query,
the data priority for transmission by the IoT device,
a quality of service of the data for the transmission by the IoT device,
the amount of the data for the transmission by the IoT device,
the IoT device not having an established ID with the RF source device,
a hardware ID for the IoT device,
a unique ID (UID) for the IoT device,
a password associated with the IoT device,
a Zone ID,
a configuration parameter of the group discovery query,
a beam ID,
a cell ID,
an RF source ID, or
an RF reader ID.

11. The apparatus of claim 10, wherein the group discovery query comprises a parameter, wherein the response to the group discovery query is on the resource associated with the set of IoT devices and is based on the parameter in the group discovery query.

12. The apparatus of claim 1, wherein the at least one processor is further configured to:
receive, after transmission of the response, an additional transmission comprising one or more of:
an indication to use a new identifier (ID) or to continue using a prior ID used in the response to the group discovery query,
first timing information for an additional query,
resource information for the additional query,
a continuous wave configuration for the additional query, wherein the continuous wave configuration for the additional query comprises at least one of a time, a frequency, a type of waveform, a type of modulation, or a type of coding,
second timing information for the IoT device,
a request for class information from the IoT device,
data from a radio frequency source,
the additional query for the IoT device, or
a command for the IoT device.

13. The apparatus of claim 1, wherein the at least one processor is further configured to:
exchange data with the RF source device based on at least one of:
indicated data resources corresponding to a radio frequency device identifier (RFID) device,
a resource mapped to the resource for sending an identifier for the IoT device,
the IoT device class,
a measurement of a signal carrying the group discovery query,
the data priority for transmission by the IoT device,
a quality of service of the data for the transmission by the IoT device,
the amount of the data for the transmission by the IoT device,
the IoT device not having an established ID with the RF source device,
a hardware ID for the IoT device,
a unique ID (UID) for the IoT device,
a password associated with the IoT device,
a Zone ID,
a configuration parameter of the group discovery query,
a beam ID,
a cell ID,
an RF source ID, or
an RF reader ID.

14. The apparatus of claim 1, wherein the at least one processor is further configured to:
consider a previous identifier (ID) with a source of the group discovery query to be expired based on at least one of:
a timer expiration,
passage of a duration of time,
completion of a read connection, or
an indication in a write or a read session from a radio frequency (RF) source, an RF reader, or a wireless device indicating a connection expiration.

15. The apparatus of claim 1, wherein the group discovery query is received in a beamformed signal from the RF source device and carries beam information.

16. The apparatus of claim 15, wherein the response includes the beam information and one or more of an RF source identifier (ID) or an IoT device ID.

17. The apparatus of claim 16, wherein the response is transmitted in a resource based on a beam ID, the RF source ID, the IoT device ID, an RF reader ID, or a cell ID.

18. The apparatus of claim 15, wherein the at least one processor is further configured to:
measure one or more beams; and
report measurement of the one or more beams indicating at least one of an RF source ID, a beam ID, a cell ID, or an RF reader ID.

19. The apparatus of claim 1, wherein the set of IoT devices comprises a radio frequency identifier (RFID) tag device, a backscattering-based communications device, a user equipment (UE) comprising the RFID tag device, or a UE comprising the backscattering-based communications device.

20. An apparatus for wireless communication at a wireless device, comprising:
a memory; and
at least one processor coupled to the memory and, based at least in part on information stored in the memory, the at least one processor is configured to:
transmit a group discovery query for a set of Internet-of-things (IoT) devices, the set of IoT devices based on at least one of (a) an IoT device class, (b) a measurement type, (c) a data priority, (d) a type of information carried by the set of IoT devices, (e) a presence of data, (f) an amount of the data, (g) a distance from the wireless device, or (h) a set of identifiers (IDs) for the set of IoT devices; and
receive a response to the group discovery query from an IoT device belonging to the set of IoT devices.

21. The apparatus of claim 20, further comprising a transceiver coupled to the at least one processor, wherein, to transmit the group discovery query for the set of IoT devices, the at least one processor is further configured to:
transmit, using the transceiver, a plurality of group discovery queries, each query transmitted at a transmission power associated with a corresponding set of IoT devices, wherein the plurality of group discovery queries comprises the group discovery query.

22. The apparatus of claim 20, wherein the response to the group discovery query indicates an identifier (ID) for the IoT device that was previously established between the IoT device and the wireless device.

23. The apparatus of claim 20, wherein the response to the group discovery query comprises an identifier (ID) indicating that the IoT device does not have an established ID with the wireless device, the ID comprising at least one of:
an invalid ID, or
the ID selected from a set of IDs for unknown IoT devices.

24. The apparatus of claim 20, wherein at least one of a resource, a time, an offset, a scrambling sequence, or an IoT device ID for the response to the group discovery query is based on one or more of:
the IoT device class,
a measurement of a signal carrying the group discovery query,
the data priority for transmission by the IoT device,
a quality of service of the data for the transmission by the IoT device,
the amount of the data for the transmission by the IoT device,
the IoT device not having an established ID with the wireless device,
a hardware ID for the IoT device,
a unique ID (UID) for the IoT device,
a password associated with the IoT device,
a Zone ID,
a configuration parameter of the group discovery query,
a beam ID,
a cell ID,
an RF source ID, or
an RF reader ID.

25. The apparatus of claim 24, wherein the group discovery query comprises a parameter, wherein the response to the group discovery query is on the resource associated with the set of IoT devices and is based on the parameter in the group discovery query.

26. The apparatus of claim 20, wherein the at least one processor is further configured to:
transmit, after receipt of the response, an additional transmission comprising one or more of:
an indication to use a new identifier (ID) or to continue using a prior ID used in the response to the group discovery query,
first timing information for an additional query,
resource information for the additional query,
a continuous wave configuration for the additional query, wherein the continuous wave configuration for the additional query comprises at least one of a time, a frequency, a type of waveform, a type of modulation, or a type of coding,
second timing information for the IoT device,
a request for class information from the IoT device,
data from a radio frequency source,
the additional query for the IoT device, or
a command for the IoT device.

27. The apparatus of claim 20, wherein the at least one processor is further configured to:
exchange data with the IoT device based on at least one of:
indicated data resources corresponding to a radio frequency device identifier (RFID) device,
a resource mapped to the resource for sending an identifier for the IoT device,
the IoT device class,
a measurement of a signal carrying the group discovery query,
the data priority for transmission by the IoT device,
a quality of service of the data for the transmission by the IoT device,
the amount of the data for the transmission by the IoT device,
the IoT device not having an established ID with the wireless device,
a hardware ID for the IoT device,
a unique ID (UID) for the IoT device,
a password associated with the IoT device,
a Zone ID,
a configuration parameter of the group discovery query,
a beam ID,
a cell ID,
an RF source ID, or
an RF reader ID.

28. The apparatus of claim 20, wherein the group discovery query is transmitted in a beamformed signal from the wireless device and carries beam information, wherein the response includes the beam information and one or more of a cell ID, an RF source identifier (ID) or an IoT device ID.

29. The apparatus of claim 28, wherein the at least one processor is further configured to:
transmit one or more beams; and
receive, from the IoT device, a measurement report for the one or more beams indicating at least one of the cell ID, the RF source ID, a beam ID, or an RF reader ID.

30. A method of wireless communication at an IoT device, comprising:
receiving a group discovery query for a set of IoT devices, the set of IoT devices based on at least one of an IoT device class, a measurement type, a data priority, a type of information carried by the set of IoT devices, a presence of data, an amount of the data, a distance from a radio frequency (RF) source device, or a set of identifiers for the set of IoT devices; and
transmitting a response to the group discovery query based on the IoT device belonging to the set of IoT devices.
